(19) United States
(12) Patent Application Publication
(10) Pub. No.: US 2024/0177224 A1
(43) Pub. Date: May 30, 2024

(54) COMMODITY SALES DATA PROCESSING DEVICE AND COMMODITY SALES DATA PROCESSING METHOD

(71) Applicant: Toshiba Tec Kabushiki Kaisha, Tokyo (JP)

(72) Inventor: Kazuyuki IMURA, Izu Shizuoka (JP)

(21) Appl. No.: 18/458,948

(22) Filed: Aug. 30, 2023

(30) Foreign Application Priority Data
Nov. 24, 2022 (JP) 2022-187822

(51) Int. Cl. G06Q 30/0601; G06Q 20/32

(52) U.S. Cl. CPC G06Q 30/0641; G06Q 20/3276

(57) ABSTRACT

According to an embodiment, a commodity sales data processing device includes a communication interface and a control unit. The control unit receives a commodity code from a first terminal for an item in a sales transaction and stores the commodity code along with a payment code. The control unit also receives a holding instruction from the first terminal for an item registered in the sales transaction, generates holding information in which the commodity code for the item to be held, first terminal identification information, and a holding location for the item are associated with each other. The control unit outputs a picking instruction to a second terminal and transmits sales transaction information to a payment device when a payment device sends the payment code associated with the sales transaction information.

### CROSS-REFERENCE TO RELATED APPLICATION

This application is based upon and claims the benefit of priority from Japanese Patent Application No. 2022-187822, filed Nov. 24, 2022, the entire contents of which are incorporated herein by reference.

### FIELD

Embodiments described herein relate generally to a commodity sales data processing device and a commodity sales data processing method.

### BACKGROUND

There is a system that allows a customer shopping in a store to register an item for purchase at a shopping terminal, issue an instruction to hold the registered item, and receive the held item upon payment.

Such a system generally assumes that all the registered items are to be held, and thus do not account for a possible mix of items that may include those a customer wants to carry to a cash register (for example, commodities that are easily spoilt such as perishable food) and those that the customer wants to request a holding until a later time.

### BRIEF DESCRIPTION OF THE DRAWINGS

FIG. 1 is a block diagram of a commodity sales data processing system.

FIG. 2 is a hardware block diagram of a server device.

FIG. 3 is a diagram illustrating an example of a data structure of a commodity master data.

FIG. 4 is a diagram illustrating an example of a data structure of a holding location master data.

FIG. 5 is a diagram illustrating an example of a data structure of a commodity registration file.

FIG. 6 is a diagram illustrating an example of a data structure of a holding instruction file.

FIG. 7 is a hardware block diagram of a tablet terminal.

FIG. 8 is a hardware block diagram of a picker mobile terminal.

FIG. 9 is a hardware block diagram of a self-service POS terminal.

FIG. 10 is a functional block diagram illustrating functional aspects of a server device.

FIG. 11 is a functional block diagram illustrating functional aspects of a tablet terminal.

FIG. 12 is a functional block diagram illustrating functional aspects of a picker mobile terminal.

FIG. 13 is a functional block diagram illustrating functional aspects of a self-service POS terminal.

FIG. 14 is a flowchart illustrating an example of processing performed by a commodity sales data processing system according to an embodiment.

FIG. 15 is a flowchart illustrating an example of commodity registration and holding instruction acquisition performed by a server device.

FIG. 16 is a flowchart illustrating an example of holding work declaration acquisition and holding status updating.

FIG. 17 is a flowchart illustrating an example of payment execution instruction and notification instruction.

FIG. 18 is a flowchart illustrating an example of processing performed by a tablet terminal.

FIG. 19 is a flowchart illustrating an example of processing performed by a picker mobile terminal.

FIG. 20 is a flowchart illustrating an example of processing performed by a self-service POS terminal.

FIG. 21 is a diagram illustrating an example of a commodity registration screen displayed on a tablet terminal.

FIG. 22 is a diagram illustrating an example of holding request input screen for holdable commodities.

FIG. 23 is a diagram illustrating an example of a screen indicating that holding of the commodities is complete.

FIG. 24 is a diagram illustrating an example of a commodity registration screen.

FIG. 25 is a diagram illustrating an example of a screen for declaring to take charge to pick held commodities displayed on a picker mobile terminal.

FIG. 26 is a diagram illustrating an example of a screen illustrating a storage location and a holding location of held commodities.

FIG. 27 is a diagram illustrating an example of a screen displayed when a customer starts payment.

FIG. 28 is a diagram illustrating an example of a screen displayed when not all of commodities requested to be held are picked into the holding location when a customer starts payment.

### DETAILED DESCRIPTION

A problem to be solved by embodiments is to provide an improved commodity sales data processing device and a commodity sales data processing method permitting the performing of payments without requiring a customer to perform a special operation even if the transaction includes a commodity to be held and a commodity not to be held.

In general, according to one embodiment, a commodity sales data processing device includes a communication interface and a control unit. The control unit is configured to: receive a commodity code from a first terminal for an item being registered in a sales transaction and store the commodity code in association with a payment code as sales transaction information; receive a holding instruction from the first terminal for an item registered in the sales transaction that is a holdable commodity; generate commodity holding information in which the commodity code identifying the item instructed to be held, terminal identification information identifying the first terminal, and a holding location of the item are associated with each other; output a picking instruction to a second terminal, the picking instruction including the commodity code of the item instructed to be held and the holding location for the item; and transmit the sales transaction information to a payment device when the payment device sends the payment code associated with the sales transaction information.

An embodiment in which a commodity sales data processing device is applied to a commodity sales data processing system 10 will be described with reference to the drawings.

### (Schematic Configuration of Commodity Sales Data Processing System)

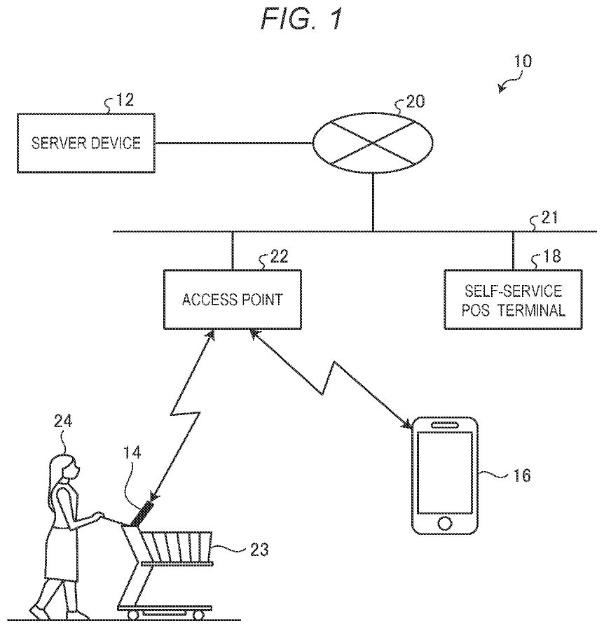

A schematic configuration of the commodity sales data processing system 10 will be described with reference to FIG. 1. FIG. 1 is a block diagram illustrating an example of the schematic configuration of the commodity sales data processing system 10.

The commodity sales data processing system 10 is a system that allows a customer 24 shopping in a store to request a holding of an item for subsequent retrieval or the like. For example, a holding may be desirable if a commodity to be purchased is large, heavy, or otherwise difficult to transport. The commodity requested for holding can be temporarily stored at a payment location in the store, and then handed over when the customer 24 performs payment.

The commodity sales data processing system 10 includes a server device 12, a tablet terminal 14 disposed on a shopping cart 23 handled by a customer 24, a picker mobile terminal 16 carried by a picker (shop assistant) that picks commodities to be held as instructed by the customer 24 and places the picked commodities in a holding location, and a self-service POS terminal 18. The tablet terminal 14 and the picker mobile terminal 16 perform wireless communication with an access point 22 disposed in the store. The tablet terminal 14 may be connected to a cloud server (store server) via a mobile communication network. The access point 22 and the self-service POS terminal 18 are connected to the server device 12 via an in-store network 21 and an Internet 20.

The server device 12 controls the overall processing performed by the commodity sales data processing system 10. Specifically, when the customer 24 uses the tablet terminal 14 to read code information such as a barcode attached to a commodity to be purchased, the server device 12 acquires the code information and registers the commodity. If the commodity registered by the customer 24 is a holdable commodity, the server device causes the tablet terminal 14 to display information inquiring of the customer 24 whether to hold the commodity, and performs holding instruction acquisition of acquiring the request of the customer 24. If the customer 24 requests holding of the commodity, the server device 12 determines a holding location of the commodity, causes the picker mobile terminal 16 to display the information requesting the holding of the commodity, and acquires a work declaration of the picker. The server device 12 performs holding status updating of acquiring information input by the picker to pick commodities, to the picker mobile terminal 16 according to progress of a holding work. When the customer 24 issues an instruction to perform payment to the self-service POS terminal 18, the server device 12 performs payment execution instruction of instructing execution of payment. When the payment execution instruction is to be performed, the server device 12 performs notification instruction of causing the self-service POS terminal 18 to perform notification on condition that not picking of all the commodities instructed to be held into the holding location is complete. The server device 12 may be a cloud server (store server). The server device 12 is an example of a commodity sales data processing device.

When the customer 24 registers a commodity to be purchased, the tablet terminal 14 reads code information attached to the commodity. When the instruction from the server device 12 is received or a response from the server device 12 is received, the tablet terminal 14 displays various types of information described below and acquires instruction information from the customer 24. Specifically, the tablet terminal 14 displays a result that the commodity is registered by the server device 12. The tablet terminal 14 acquires a holding instruction of the customer 24 for a holdable commodity, and outputs the holding instruction to the server device 12. The tablet terminal 14 displays information indicating that the holding of the commodity for which the customer 24 requests holding has been completed, that is, the commodity that the customer 24 requests holding is picked into the holding location. When the customer 24 ends shopping and performs payment, the tablet terminal 14 displays a payment code on the screen thereof. The displayed payment code is read by the self-service POS terminal 18, and the payment is started. The tablet terminal 14 is an example of a first mobile terminal.

The picker mobile terminal 16 is carried by a picker that performs a picking work of the commodity instructed to be held. The picker mobile terminal 16 receives an instruction from the server device 12 and displays various types of information related to the holding of the commodity. The picker mobile terminal 16 acquires information indicating a progress status of the picking work of the commodity to be performed by the picker, and outputs the information to the server device 12. Specifically, the picker mobile terminal 16 displays information indicating that a holding instruction of a commodity from the customer 24 is present. The picker mobile terminal 16 receives the holding instruction of the commodity, acquires information indicating a declaration of performing the work by an available picker, and outputs the information to the server device 12. The picker mobile terminal 16 acquires information indicating that the commodity instructed to be held is held into a predetermined holding location by the picker, and outputs the information to the server device 12. A plurality of pickers are present in the store, and each of the pickers carries a picker mobile terminal 16. Therefore, a plurality of picker mobile terminals 16 are present. The picker mobile terminal 16 is an example of a second mobile terminal.

When an instruction from the server device 12 is received, the self-service POS terminal 18 performs payment related to the payment code presented by the customer 24 via the tablet terminal 14. If not the holding of all the commodities instructed by the customer 24 to be held is complete, the self-service POS terminal 18 receives the instruction from the server device 12 and performs notification. A plurality of self-service POS terminals 18 are present, and the customer 24 performs payment on an available self-service POS terminal 18. The self-service POS terminal 18 is an example of a payment device.

The configuration of the commodity sales data processing system 10 according to the embodiment is not limited to the example of FIG. 1. For example, the tablet terminal 14 may be a mobile terminal such as a smartphone carried by a customer. The self-service POS terminal 18 may be an interpersonal POS terminal. The tablet terminal 14 or the mobile terminal carried by the customer can display a payment code and perform payment via the self-service POS terminal 18. The tablet terminal 14 is not limited thereto, and may have a function of performing payment in each mobile terminal using a settlement method such as credit card settlement, code settlement, or other electronic money settlement.

### (Hardware Configuration of Server Device)

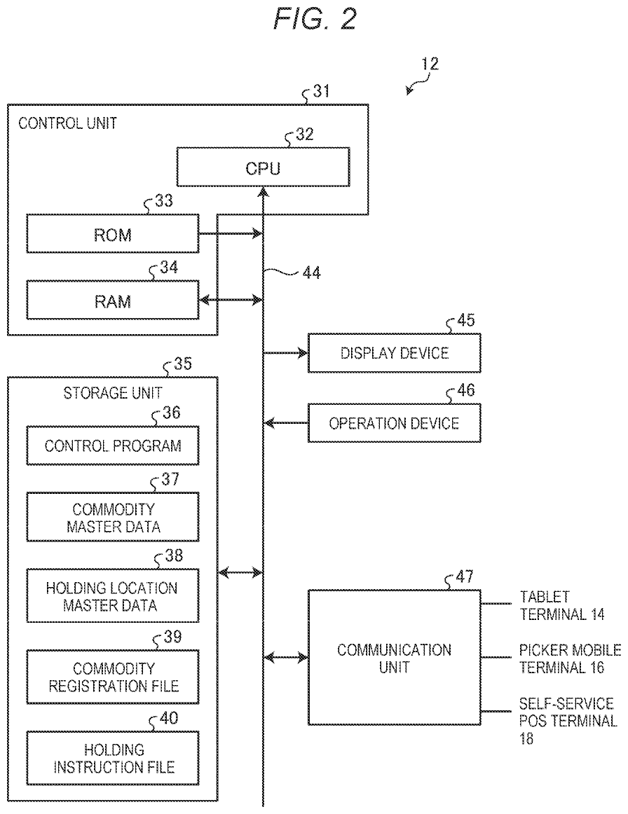

A hardware configuration of the server device 12 will be described with reference to FIG. 2. FIG. 2 is a hardware block diagram illustrating an example of the hardware configuration of the server device.

The server device 12 includes a control unit 31, a storage unit 35, a display device 45, an operation device 46, and a communication unit 47.

The control unit 31 includes a CPU 32, a ROM 33, and a RAM 34. The CPU 32 integrally controls each unit of the server device 12. The ROM 33 stores various programs. The RAM 34 is a workspace for holding programs and various types of data.

The CPU 32, the ROM 33, and the RAM 34 are connected via an internal bus 44. The control unit 31 executes various types of processing by the CPU 32 operating according to a program stored in the storage unit 35 and loaded into the RAM 34.

The storage unit 35 includes a storage medium such as an HDD or a flash memory, and stores a storage content even if the power supply is cut off. The storage unit 35 stores a control program 36, commodity master data 37, holding location master data 38, a commodity registration file 39, and a holding instruction file 40.

The control program 36 is a program that controls an overall operation of the server device 12.

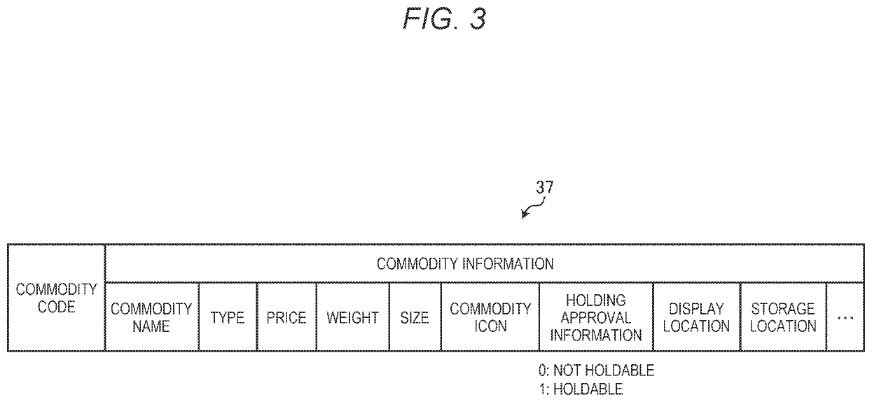

The commodity master data 37 is a master file that stores information related to a commodity sold in the store. A specific structure of the commodity master data 37 will be described later (see FIG. 3).

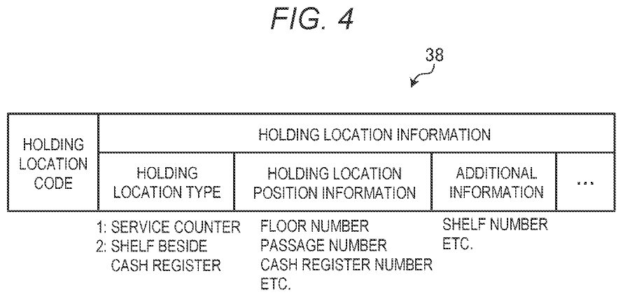

The holding location master data 38 is a master file that stores information related to a holding location of a holdable commodity. A specific structure of the holding location master data 38 will be described later (see FIG. 4).

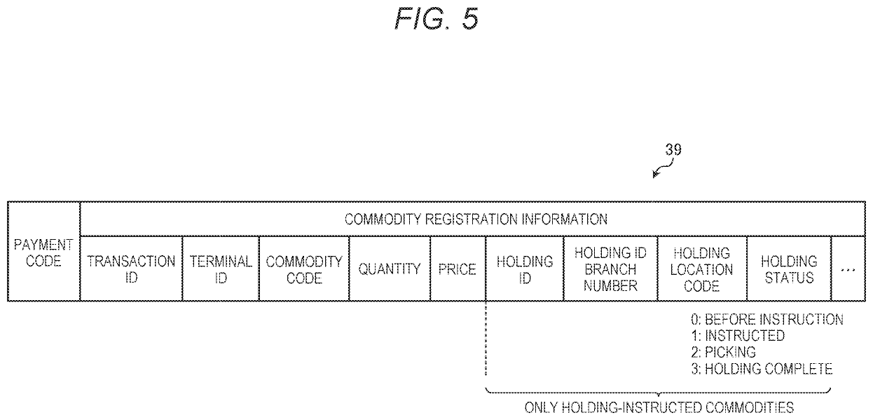

The commodity registration file 39 is a file that stores information related to a commodity code read by the tablet terminal 14, that is, information related to a commodity purchased by the customer 24. A specific structure of the commodity registration file 39 will be described later (see FIG. 5).

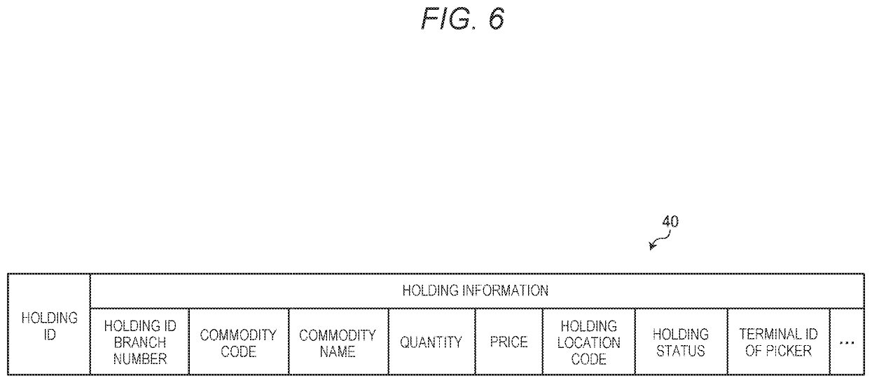

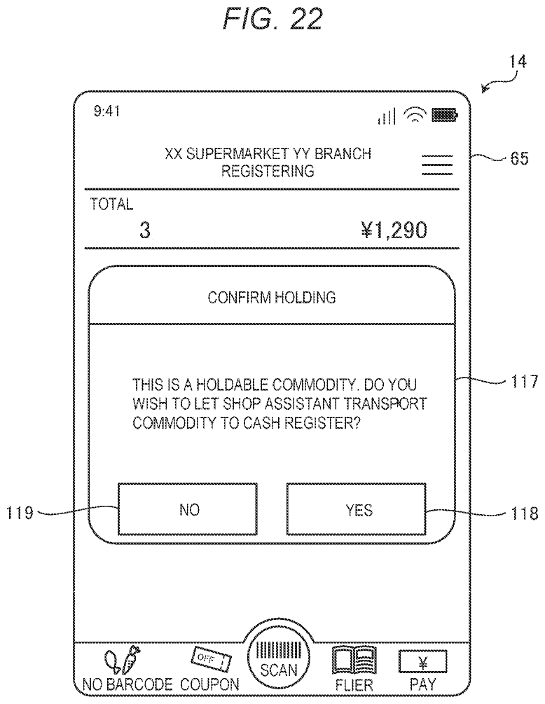

The holding instruction file 40 is a file that stores information related to a held commodity and is generated when a holding wish button 118 (see FIG. 22) of the tablet terminal 14 is pressed by customer 24 to instruct the hold of a commodity. A specific structure of the holding instruction file 40 will be described later (see FIG. 6). The holding instruction file 40 is an example of commodity holding information.

The display device 45 displays a screen generated according to an instruction of the control unit 31. The display device 45 is implemented with, for example, a device such as a liquid crystal display (LCD) or an organic electro-luminescence (EL).

The operation device 46 acquires an operation input by an operator, and transmits the operation to the control unit 31. The operation device 46 is implemented with, for example, a device such as a touch panel or a keyboard.

The communication unit 47 is a communication connection unit that communicates with the tablet terminal 14, the picker mobile terminal 16, and the self-service POS terminal 18.

### (Data Structure of Various Types of Data Stored in Server Device)

Data structures of various types of data stored in the server device 12 will be described with reference to FIGS. 3 to 6. FIG. 3 is a diagram illustrating an example of a data structure of the commodity master data. FIG. 4 is a diagram illustrating an example of a data structure of the holding location master data. FIG. 5 is a diagram illustrating an example of a data structure of the commodity registration file. FIG. 6 is a diagram illustrating an example of a data structure of the holding instruction file.

As illustrated in FIG. 3, the commodity master data 37 is associated with a commodity code for identifying a commodity, and stores commodity information about the commodity corresponding to the commodity code. The commodity information includes a commodity name, a type, a price, a weight, a size, a commodity icon, holding approval information, a display location, a storage location, and the like.

The holding approval information is independently set by the store based on the weight and the size of the commodity. For example, a commodity to which “0” is assigned to the holding approval information is a commodity that cannot be held, and a commodity to which “1” is assigned to the holding approval information is a holdable commodity.

As illustrated in FIG. 4, the holding location master data 38 is associated with a holding location code for uniquely identifying a holding location, and stores holding location information corresponding to the holding location code. The holding location information includes a holding location type, holding location position information, additional information, and the like.

The holding location type includes, for example, a service counter of a store, a shelf beside a cash register, and the like.

The holding location position information includes a floor number of the store, a passage number, a cash register number, and the like.

The additional information includes a shelf number and the like.

The commodity registration file 39 is generated by the server device 12 receiving the commodity code read by the tablet terminal 14. As illustrated in FIG. 5, the commodity registration file 39 is associated with a payment code for uniquely identifying a commodity registered by an instruction of the customer 24, and stores commodity registration information corresponding to the payment code. The commodity registration information includes a transaction ID, a terminal ID, a commodity code, a quantity, a price, a holding ID, a holding ID branch number, a holding location code, a holding status, and the like.

The transaction ID is issued by the server device 12 when the customer 24 checks in the store or when the first commodity is registered.

The terminal ID is terminal identification information that uniquely identifies the tablet terminal 14 operated by the customer 24. The terminal identification information and the code information are output to the server device 12 when the code self-service the commodity purchased by the customer 24 is read. The commodity registration file 39 may acquire, from the tablet terminal 14, and store user identification information that uniquely identifies the customer 24 instead of the terminal identification information that uniquely identifies the tablet terminal 14. The user identification information that uniquely identifies the customer 24 is, for example, a user number registered in the store in advance by the customer 24.

Each of the holding ID, the holding ID branch number, the holding location code, and the holding status is stored only for a holding instruction commodity that the customer 24 requests holding.

The holding ID is identification information uniquely identifies that the commodity is a commodity requested for holding by the customer 24. The server device 12 issues the holding ID when a request for holding the commodity is acquired from the customer 24.

The holding ID branch number is information issued by the server device 12 indicating that the request is a holding request from the same customer 24 who requested the holding of a plurality of commodities. For example, if the customer 24 requests holding of a first commodity, the server device 12 issues a new holding ID. At this time, since the commodity is the first commodity that the customer 24 requested for holding, the server device 12 simultaneously issues the holding ID branch number “1”. If the same customer 24 requests holding of a second commodity, the server device 12 assigns the same holding ID to the second commodity as that issued earlier for the customer, and simultaneously issues a holding ID branch number “2” indicating that the commodity is the second commodity for which the customer 24 requests holding.

The holding location code is information indicating the holding location of the commodity requested to be held. The holding location may be set by the server device 12 or may be selected by the customer 24. For the second and subsequent commodities that the same customer 24 requests holding, the server device 12 sets the same holding location as that of the first commodity. Further, if there is only one picker, or if multiple pickers handle holding instructions associated with the same terminal ID, the picker may designate the holding location.

The holding status is information indicating a state of the commodity requested to be held. The holding status stores, for example, one of “0” indicating that the instruction to the picker is not yet performed, “1” indicating that the holding instruction to the picker is performed, “2” indicating that the picker that received the instruction is picking the commodity, and “3” indicating that the picking into the holding location is complete. The holding status is sequentially updated in response to the information from the picker mobile terminal 16.

As illustrated in FIG. 6, the holding instruction file 40 is associated with the holding ID issued by the server device 12, and stores holding information corresponding to the holding ID. The holding information includes a holding ID branch number, a commodity code, a commodity name, a quantity, a price, a holding location code, a holding status, a terminal ID of the picker, and the like.

The server device 12 outputs the holding instruction file 40 to the picker mobile terminal 16. Then, the picker receiving the holding instruction file 40 declares that the picking work for transporting the instructed commodity to the holding location will be performed. Specifically, the picker inputs, to the picker mobile terminal 16, that the picking work will be performed as requested. When the picking work declaration is input, the picker mobile terminal 16 updates the holding status of the holding instruction file 40 to “picking”. Then, the picker mobile terminal 16 outputs, to the server device 12, the holding instruction file 40 with the holding status updated. When the picking work is completed, the picker inputs, to the picker mobile terminal 16, information indicating that the work has been complete. When picking work complete notice is input, the picker mobile terminal 16 updates the holding status of the holding instruction file 40 to “holding complete”. Then, the picker mobile terminal 16 outputs, to the server device 12, the holding instruction file 40 with the holding status updated.

### (Hardware Configuration of Tablet Terminal)

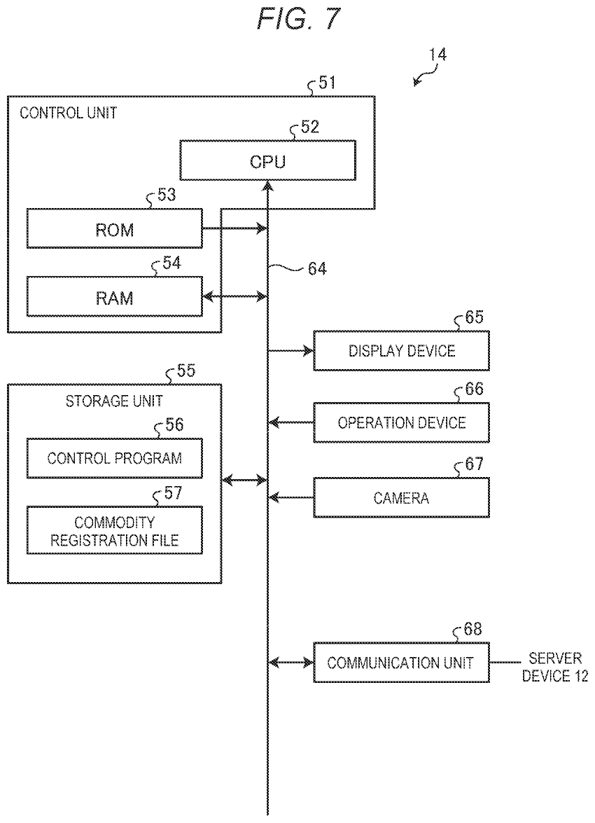

A hardware configuration of the tablet terminal 14 will be described with reference to FIG. 7. FIG. 7 is a hardware block diagram illustrating example of the hardware an configuration of the tablet terminal.

The tablet terminal 14 includes a control unit 51, a storage unit 55, a display device 65, an operation device 66, a camera 67, and a communication unit 68.

The control unit 51 includes a CPU 52, a ROM 53, and a RAM 54. The CPU 52 controls each unit of the tablet terminal 14. The ROM 53 stores various programs. The RAM 54 is a workspace for holding programs and various types of data.

The CPU 52, the ROM 53, and the RAM 54 are connected via an internal bus 64. The control unit 51 executes various types of processing by the CPU 52 operating according to a program stored in the storage unit 55 and loaded into the RAM 54.

The storage unit 55 includes a storage medium such as an HDD or a flash memory, and stores a storage content even if the power supply is cut off. The storage unit 55 stores a control program 56 and a commodity registration file 57.

The control program 56 is a program that controls an overall operation of the tablet terminal 14.

The commodity registration file 57 is a file in which the commodity information about the commodity corresponding to the commodity code registered by customer 24. Each time the customer 24 registers code information, the tablet terminal 14 acquires a commodity registration file 57 from the server device 12.

The display device 65 displays a screen generated according to an instruction from the control unit 51. The display device 65 is implemented with, for example, a device such as an LCD or an organic EL.

The operation device 66 acquires an operation input by an operator, and transmits the operation to the control unit 51. The operation device 66 is implemented with, for example, a device such as a touch panel or a keyboard.

The camera 67 images a barcode or a two-dimensional code of a commodity to be purchased.

The communication unit 68 is a communication connection unit for communicating with the server device 12.

### (Hardware Configuration of Picker Mobile Terminal)

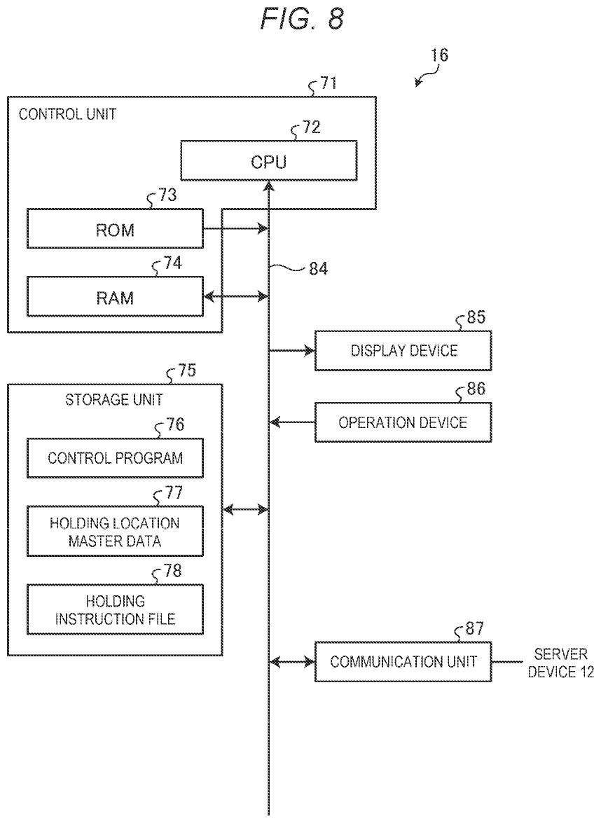

A hardware configuration of the picker mobile terminal 16 will be described with reference to FIG. 8. FIG. 8 is a hardware block diagram illustrating an example of the hardware configuration of the picker mobile terminal.

The picker mobile terminal 16 includes a control unit 71, a storage unit 75, a display device 85, an operation device 86, and a communication unit 87.

The control unit 71 includes a CPU 72, a ROM 73, and a RAM 74. The CPU 72 comprehensively controls each unit of the picker mobile terminal 16. The ROM 73 stores various programs. The RAM 74 is a workspace for holding programs and various types of data.

The CPU 72, the ROM 73, and the RAM 74 are connected via an internal bus 84. The control unit 71 executes various types of processing by the CPU 72 operating according to a program stored in the storage unit 75 and loaded into the RAM 74.

The storage unit 75 includes a storage medium such as an HDD or a flash memory, and stores a storage content even if the power supply is cut off. The storage unit 75 stores a control program 76, a holding location master data 77, and a holding instruction file 78.

The control program 76 is a program that controls an overall operation of the picker mobile terminal 16.

The holding location master data 77 is the same master file as the above-described holding location master data 38, which is stored in the server device 12.

The holding instruction file 78 is a file that stores holding information related to one branch number among the above-described holding instruction file 40 stored in the server device 12. Each time holding of a commodity is instructed, the holding instruction file 78 is output from the server device 12 to the picker mobile terminal 16 for each commodity.

The display device 85 displays a screen generated according to an instruction from the control unit 71. The display device 85 is implemented with, for example, a device such as an LCD or an organic EL.

The operation device 86 acquires an operation input by an operator, and transmits the operation to the control unit 71. The operation device 86 is implemented with, for example, a device such as a touch panel or a keyboard.

The communication unit 87 is a communication connection unit for communicating with the server device 12.

### (Hardware Configuration of Self-Service POS Terminal)

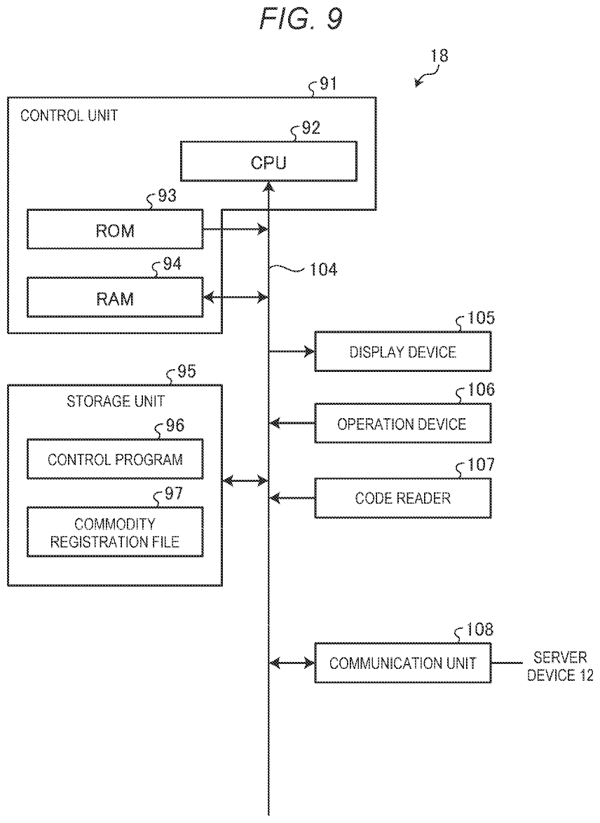

A hardware configuration of the self-service POS terminal 18 will be described with reference to FIG. 9. FIG. 9 is a hardware block diagram illustrating an example of the hardware configuration of the self-service POS terminal.

The self-service POS terminal 18 includes a control unit 91, a storage unit 95, a display device 105, an operation device 106, a code reader 107, and a communication unit 108.

The control unit 91 includes a CPU 92, a ROM 83, and a RAM 94. The CPU 92 controls each unit of the self-service POS terminal 18. The ROM 83 stores various programs. The RAM 94 is a workspace for holding programs and various types of data.

The CPU 92, the ROM 93, and the RAM 94 are connected via an internal bus 104. The control unit 91 executes various types of processing by the CPU 92 operating according to a program stored in the storage unit 95 and loaded into the RAM 94.

The storage unit 95 includes a storage medium such as an HDD or a flash memory, and stores a storage content even if the power supply is cut off. The storage unit 95 stores a control program 96 and a commodity registration file 97.

The control program 96 is a program that controls an overall operation of the self-service POS terminal 18.

The commodity registration file 97 is the same file as the above-described commodity registration file 39 stored in the server device 12.

The display device 105 displays a screen generated according to an instruction from the control unit 91. The display device 105 is implemented with, for example, a device such as an LCD or an organic EL.

The operation device 106 acquires an operation input by an operator, and transmits the operation to the control unit 91. The operation device 106 is implemented with, for example, a device such as a touch panel or a keyboard.

The code reader 107 is, for example, a barcode reader that reads a payment code displayed on the display device 65 of the tablet terminal 14.

The communication unit 108 is a communication connection unit for communicating with the server device 12.

### (Functional Configuration of Server Device)

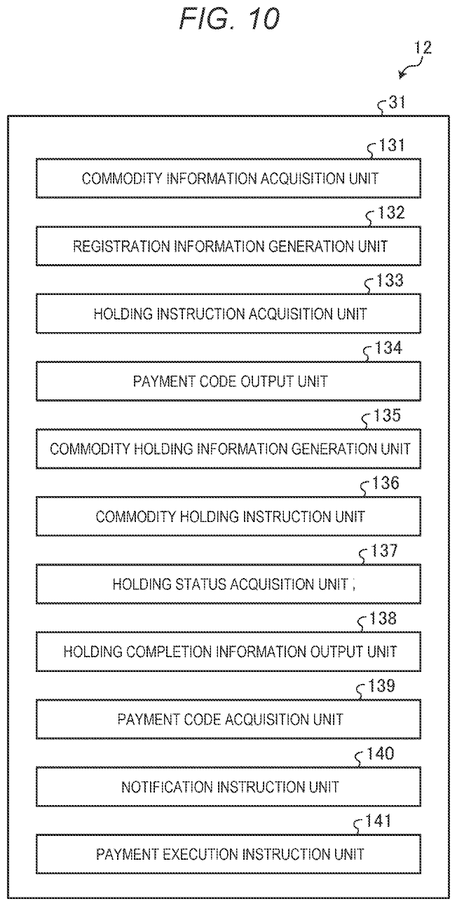

A functional configuration of the server device 12 will be described with reference to FIG. 10. FIG. 10 is a functional block diagram illustrating an example of the functional configuration of the server device.

The control unit 31 of the server device 12 loads the control program 36 into the RAM 34 and operates the control program 36, thereby implementing, as functional units, a commodity information acquisition unit 131, a registration information generation unit 132, a holding instruction acquisition unit 133, a payment code output unit 134, a commodity holding information generation unit 135, a commodity holding instruction unit 136, a holding status acquisition unit 137, a holding complete information output unit 138, a payment code acquisition unit 139, a notification instruction unit 140, and a payment execution instruction unit 141 illustrated in FIG. 10. Some or all of these functions may be implemented with dedicated hardware.

The commodity information acquisition unit 131 acquires, from the tablet terminal 14, a commodity code that uniquely identifies a commodity to be purchased by the customer 24 and terminal identification information that uniquely identifies the tablet terminal 14. In addition, the commodity information acquisition unit 131 determines whether the commodity having the acquired commodity code is a holdable commodity. In addition, the commodity information acquisition unit 131 acquires, from the tablet terminal 14, information indicating that the designation of all the commodities to be purchased is complete.

The registration information generation unit 132 generates the commodity registration file 39, in which registration information including the commodity information about the commodity to be purchased by the customer 24 is stored, and a payment code for uniquely identifying the registration information. The registration information is acquired from the tablet terminal 14. In addition, the registration information generation unit 132 outputs a content of the generated commodity registration file 39 to the tablet terminal 14. The payment code may be generated by the tablet terminal 14. For example, if the server device 12 receives a payment request from the tablet terminal 14, the server device 12 confirms that there is no unregistered commodity or R-20 commodities which cannot be purchased by juveniles. If there is no problem, the server device 12 returns a response command to the tablet terminal 14. Then, the tablet terminal 14 may acquire the response command and generate a payment code for identifying the various types of information illustrated in FIG. 5.

The holding instruction acquisition unit 133 acquires, from the tablet terminal 14, a holding instruction for a holdable commodity among the commodities to be purchased by the customer 24. When the holding instruction is acquired, the holding instruction acquisition unit 133 determines whether the holding instruction was already received from the same tablet terminal 14.

The payment code output unit 134 outputs the payment code generated by the registration information generation unit 132 to the tablet terminal 14 on the condition that the registration of all the commodities to be purchased is complete.

The commodity holding information generation unit 135 generates the holding instruction file 40 (commodity holding information) in which a commodity code, which is the commodity identification information for identifying the commodity instructed to be held, terminal identification information for identifying the holding instruction from the tablet terminal 14, and a holding location of the commodity are associated with each other. The commodity code is an example of first identification information. The terminal identification information is an example of second identification information. The commodity holding information generation unit 135 sets the holding location of the commodity instructed to be held.

The commodity holding instruction unit 136 outputs, to the picker mobile terminal 16, the holding instruction of the commodity to the holding location.

The holding status acquisition unit 137 acquires, from the picker mobile terminal 16, information indicating a holding status of the commodity instructed to be held, and updates the holding statuses registered in the commodity registration file 39 and the holding instruction file 40. The information indicating the holding status of the commodity is, for example, information declaring that a commodity picking work is to be performed and information indicating that the holding of the commodity is complete. When the commodity holding instruction unit 136 outputs, to the picker mobile terminal 16, the holding instruction of the commodity to the holding location, the holding status acquisition unit 137 updates the holding statuses registered in the commodity registration file 39 and the holding instruction file 40. The holding status acquisition unit 137 determines, based on the holding statuses, whether the holding of all the commodities instructed to be held from the same tablet terminal 14 is complete.

The holding complete information output unit 138 outputs in a displayable manner, to the tablet terminal 14, the information indicating that the holding is complete and the information indicating the holding location, on the condition that movement of the commodity instructed to be held to the holding location is complete. On the condition that payment is executed by the self-service POS terminal 18 when not the movement of all the commodities instructed to be held to the holding location is complete, the holding complete information output unit 138 outputs in a displayable manner, to the tablet terminal 14, the fact that the movement of all the commodities instructed to be held to the holding location is complete when the movement of all the commodities instructed to be held to the holding location is complete.

The payment code acquisition unit 139 acquires a payment code from the self-service POS terminal 18.

When the payment execution instruction unit 141 causes the self-service POS terminal 18 to perform the payment, the notification instruction unit 140 causes the self-service POS terminal 18 to perform notification on the condition that not picking of all the commodities instructed to be held into the holding location is complete.

When the payment code is acquired from the self-service POS terminal 18 that performs the payment, the payment execution instruction unit 141 outputs the commodity registration file 39 corresponding to the payment code to the self-service POS terminal 18. When the execution of the payment is instructed from the self-service POS terminal 18 that performs the payment, the payment execution instruction unit 141 causes the self-service POS terminal 18 to perform the payment related to the registration information registered in the commodity registration file 39.

### (Functional Configuration of Tablet Terminal)

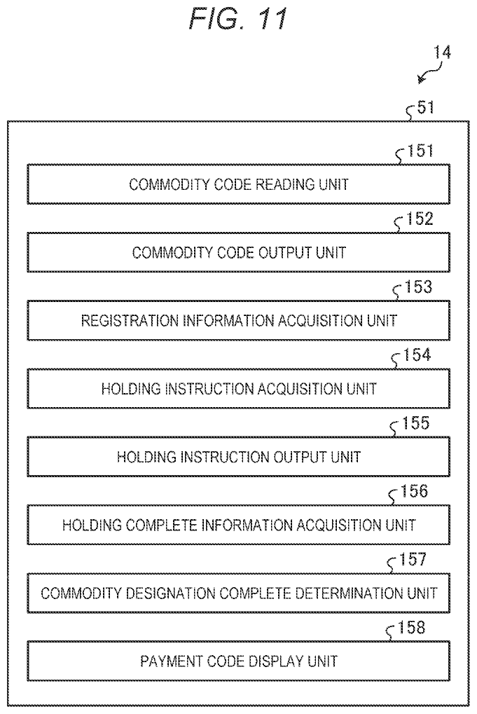

A functional configuration of the tablet terminal 14 will be described with reference to FIG. 11. FIG. 11 is a functional block diagram illustrating an example of the functional configuration of the tablet terminal.

The control unit 51 of the tablet terminal 14 loads the control program 56 into the RAM 54 and operates the control program 56, thereby implementing, as functional units, a commodity code reading unit 151, a commodity code output unit 152, a registration information acquisition unit 153, a holding instruction acquisition unit 154, a holding instruction output unit 155, a holding complete information acquisition unit 156, a commodity designation complete determination unit 157, and a payment code display unit 158 illustrated in FIG. 11. Some or all of these functions may be implemented with dedicated hardware.

The commodity code reading unit 151 reads code information including a commodity code such as a barcode or a two-dimensional code attached to a commodity.

The commodity code output unit 152 outputs, to the server device 12, the code information read by the commodity code reading unit 151 and the terminal identification information uniquely identifying the tablet terminal 14.

The registration information acquisition unit 153 acquires, from the server device 12, the commodity registration information registered in the commodity registration file 39. The registration information acquisition unit displays the acquired commodity registration information on the display device 65.

If the registered commodity is a holdable commodity, the holding instruction acquisition unit 154 acquires a holding instruction of the customer 24.

The holding instruction output unit 155 outputs, to the server device 12, the holding instruction of the customer 24 acquired by the holding instruction acquisition unit 154.

The holding complete information acquisition unit 156 acquires, from the server device 12, holding complete information indicating that the holding of the commodity instructed to be held is complete. The holding complete information acquisition unit 156 also displays the acquired holding complete information on the display device 65.

The commodity designation complete determination unit 157 determines whether the code information about all the commodities has been read by the customer 24. For example, by detecting that a button indicating that the commodity registration is complete has been pressed on the tablet terminal 14, the commodity designation complete determination unit 157 determines that reading of commodity codes is complete.

The payment code display unit 158 acquires, from the server device 12, the payment code for uniquely identifying the registration information about the commodity to be purchased, and displays the payment code on the display device 65 of the tablet terminal 14.

### (Functional Configuration of Picker Mobile Terminal)

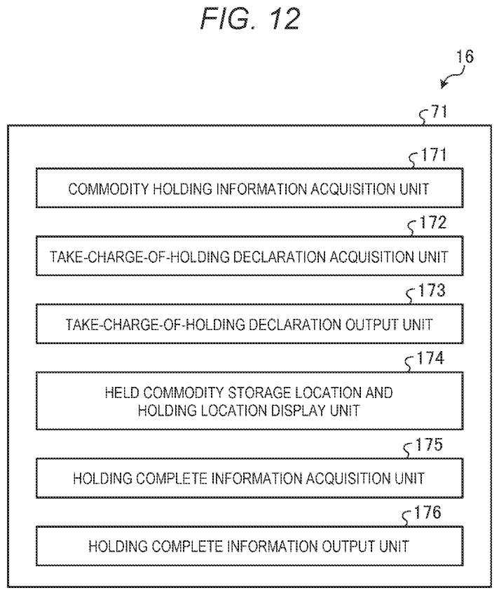

A functional configuration of the picker mobile terminal 16 will be described with reference to FIG. 12. FIG. 12 is a functional block diagram illustrating an example of the functional configuration of the picker mobile terminal.

The control unit 71 of the picker mobile terminal 16 loads the control program 76 into the RAM 74 and operates the control program 76, thereby implementing, as functional units, a commodity holding information acquisition unit 171, a take-charge-of-holding declaration acquisition unit 172, a take-charge-of-holding declaration output unit 173, a held commodity storage location and holding location display unit 174, a holding complete information acquisition unit 175, and a holding complete information output unit 176 illustrated in FIG. 12. Some or all of these functions may be implemented with dedicated hardware.

The commodity holding information acquisition unit 171 acquires, from the server device 12, the holding instruction of the commodity to the holding location.

The take-charge-of-holding declaration acquisition unit 172 acquires declaration information for performing a picking work of the commodity from a picker in response to the holding instruction acquired by the commodity holding information acquisition unit 171. Specifically, the take-charge-of-holding declaration acquisition unit 172 acquires operation information when a button on the display device 85 for declaring that the commodity is to be picked on the display device 85 is operated.

The take-charge-of-holding declaration output unit 173 outputs the declaration information acquired by the take-charge-of-holding declaration acquisition unit 172 to the server device 12.

The held commodity storage location and holding location display unit 174 displays a storage location and a holding location of the held commodity on the display device 85 of the picker mobile terminal 16.

When the commodity is carried to the holding location by the picker, a button indicating that the holding of the commodity is complete on the display device 85 of the picker mobile terminal 16 is operated and the holding complete information acquisition unit 175 acquires this operation information.

The holding complete information output unit 176 outputs the holding complete information acquired by the holding complete information acquisition unit 175 to the server device 12.

### (Functional Configuration of Self-Service POS Terminal)

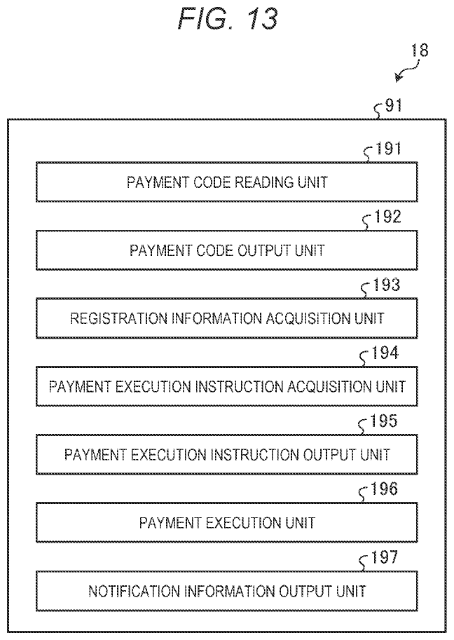

A functional configuration of the self-service POS terminal 18 will be described with reference to FIG. 13. FIG. 13 is a functional block diagram illustrating an example of the functional configuration of the self-service POS terminal 18.

The control unit 91 of the self-service POS terminal 18 loads the control program 96 into the RAM 94 and operates the control program 96, thereby implementing, as functional units, a payment code reading unit 191, a payment code output unit 192, a registration information acquisition unit 193, a payment execution instruction acquisition unit 194, a payment execution instruction output unit 195, a payment execution unit 196, and a notification information output unit 197 illustrated in FIG. 13. Some or all of these functions may be implemented with dedicated hardware.

The payment code reading unit 191 reads, by the code reader 107, the payment code displayed on the display device 65 of the tablet terminal 14 by the operation of the customer 24.

The payment code output unit 192 outputs, to the server device 12, the payment code read by the payment code reading unit 191.

The registration information acquisition unit 193 acquires, from the server device 12, the commodity registration file 39 corresponding to the payment code output by the payment code output unit 192.

The payment execution instruction acquisition unit 194 acquires an execution instruction of payment from the customer 24. Specifically, the payment execution instruction acquisition unit determines that the execution instruction for the payment processing has been acquired by detecting the pressing of a payment button displayed on the display device 105 of the self-service POS terminal 18.

The payment execution instruction output unit 195 outputs, to the server device 12, information indicating that the execution instruction for the payment is acquired by the payment execution instruction acquisition unit 194.

The payment execution unit 196 receives a payment instruction from the server device 12 and executes the payment processing.

The notification information output unit 197 acquires a notification instruction from the server device 12 if not all the commodities instructed to be held have been picked and taken to the holding location. When notification instruction is acquired from the server device 12, the notification information output unit 197 performs a notification indicating that the picking of the commodities to be held is not complete.

### (Flow of Processing Performed by Commodity Sales Data Processing System)

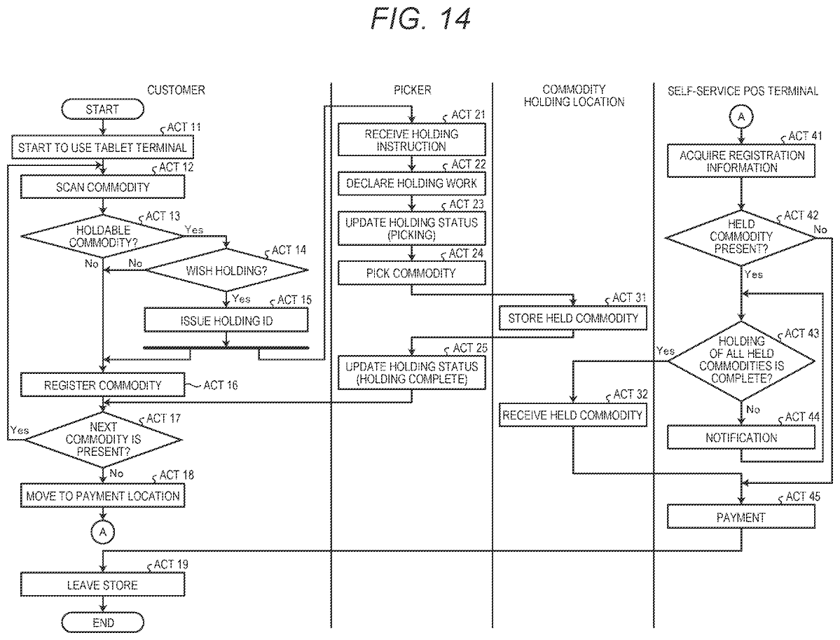

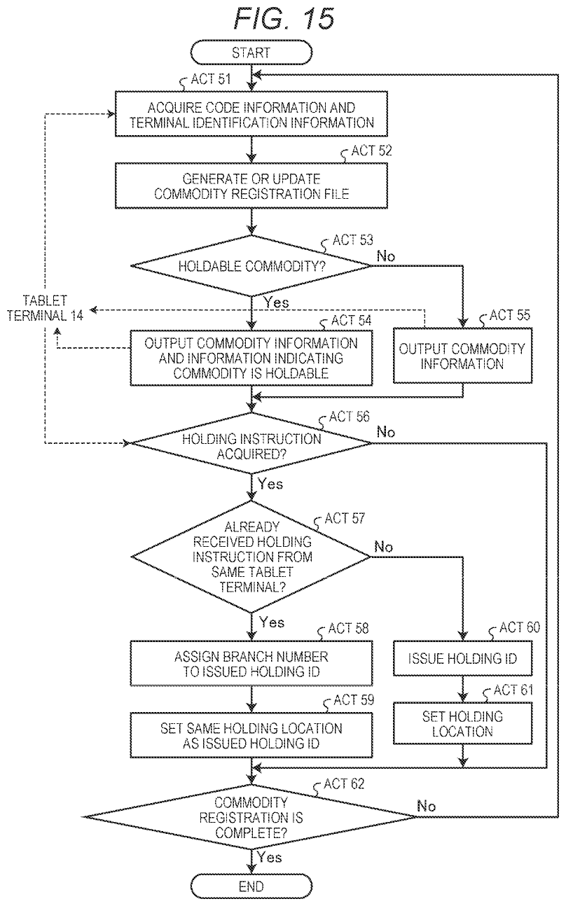

With reference to FIG. 14, a flow of processing performed by the commodity sales data processing system 10 will be described mainly from the viewpoint of operations and acts performed by the customer 24 and the picker. FIG. 14 is a flowchart illustrating an example of the flow of the processing performed by the commodity sales data processing system according to the embodiment. In particular, the flowchart of FIG. 14 is drawn by focusing on the flow of the operations, work, and the like performed by the customer 24 and the picker according to the commodity sales data processing system 10. A flow of processing performed by each of the server device 12, the tablet terminal 14, the picker mobile terminal 16, and the self-service POS terminal 18 constituting the commodity sales data processing system 10 will be described later (see FIGS. 15 to 20).

First, the flow of the operations of the customer 24 and the acts of the customer 24 using the tablet terminal 14 will be described. First, the customer 24 starts to use the tablet terminal 14, for example, when a commodity registration start button is pressed on the tablet terminal 14 (ACT 11).

The customer 24 picks up a commodity to be purchased, and reads, with the camera 67 of the tablet terminal 14, a barcode or a two-dimensional code (ACT 12).

Based on the information in the barcode or the like, the tablet terminal 14 determines whether the commodity is a holdable commodity (ACT 13). If the commodity is a holdable commodity (ACT 13: Yes), the processing proceeds to ACT 14. On the other hand, if the commodity is not a holdable commodity (ACT 13: No), the processing proceeds to ACT 16.

If it is determined in ACT 13 that the commodity is a holdable commodity, the tablet terminal 14 inquires whether the customer 24 requests a holding of the commodity (ACT 14). If the customer 24 requests holding of the commodity (ACT 14: Yes), the processing proceeds to ACT 15. On the other hand, if the customer 24 does not request holding of the commodity (ACT 14: No), the processing proceeds to ACT 16.

If the customer 24 requests holding of the commodity in ACT 14, the server device 12 issues a holding ID for uniquely identifying the commodity that is requested for holding by the customer 24 (ACT 15). Thereafter, the processing proceeds to ACT 16. A holding ID and associated information is transmitted to a picker.

If the commodity is not a holdable commodity or customer 24 does not wish a holding of a holdable commodity in ACT 14, the commodity whose code information was read in ACT 12 is registered in the server device 12 (ACT 16).

The customer 24 next determines whether there is another commodity to be purchased (ACT 17). If there is another commodity to be purchased (ACT 17: Yes), the processing returns to ACT 12. On the other hand, if there is not another commodity to be purchased (ACT 17: No), the customer 24 moves to the self-service POS terminal 18 (a payment location) (ACT 18). Thereafter, the processing proceeds to a processing sequence performed by the self-service POS terminal 18. The completion of commodity registration can be determined by, for example, the commodity designation complete determination unit 157 detecting that a button indicating that the commodity registration is complete has been operated on the tablet terminal 14.

Next, a flow of the operation of the picker and the acts of the picker in picking a held commodity will be described. The picker mobile terminal 16 carried by the picker receives a holding instruction including the holding ID issued in ACT 15 (ACT 21).

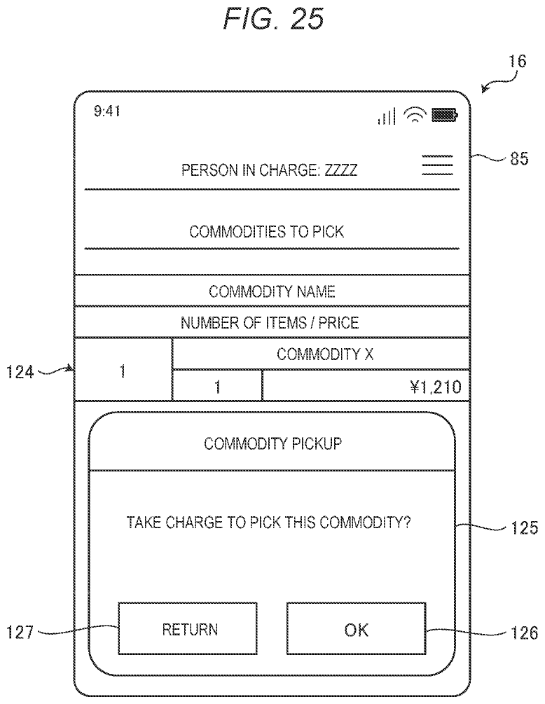

The picker declares to perform a holding work of picking the commodity requested to be held (ACT 22). Specifically, the take-charge-of-holding declaration acquisition unit 172 detects that an OK button 126 (see FIG. 25) displayed on the picker mobile terminal 16 has been pressed.

When the picker declares to perform the holding work, the holding status is updated to “picking” (ACT 23).

The picker then picks the commodity (ACT 24). That is, the picker retrieves the held commodity and takes the commodity to a holding location or the like.

The picked commodity is carried to and stored in a commodity holding location (ACT 31).

When the picker completes the holding work, the holding complete information acquisition unit 175 detects that a work complete button 144 displayed on the picker mobile terminal 16 has been pressed, and outputs information indicating that the holding work is complete to the server device 12. Then, the server device 12 updates the holding status to “holding complete” (ACT 25).

The customer 24 moves to the self-service POS terminal 18 and causes the tablet terminal 14 to display a payment code and causes the payment code reading unit 191 of the self-service POS terminal 18 to read the payment code. The self-service POS terminal 18 outputs the read payment code to the server device 12. Then, the server device 12 outputs registration information about the items corresponding to the received payment code to the self-service POS terminal 18. The self-service POS terminal 18 acquires the registration information about the items output by the server device 12 (ACT 41).

The self-service POS terminal 18 determines whether a held commodity is present in the registration information about the items (ACT 42). If it is determined that a held commodity is present (ACT 42: Yes), the processing proceeds to ACT 43. On the other hand, if a held commodity is not present (ACT 42: No), the processing proceeds to ACT 45.

If it is determined in ACT 42 that a held commodity is present, the self-service POS terminal 18 determines whether the holding of all the held commodities is complete (ACT 43). If the holding of all the held commodities is complete (ACT 43: Yes), the held items can be received or withdrawn from the commodity holding location near the self-service POS terminal 18 (ACT 32).

Thereafter, the customer 24 instructs the self-service POS terminal 18 to execute payment. Specifically, when the payment execution instruction acquisition unit 194 of the self-service POS terminal 18 determines that an input for instructing the execution of the payment is present, the self-service POS terminal 18 performs the payment (ACT 45). If the self-service POS terminal 18 and the commodity holding location are separated from each other, the customer 24 may go to the commodity holding location after completing the payment to receive the held commodity.

After completing the payment, the customer 24 leaves the store (ACT 19).

### (Flow of Processing Performed by Server Device)

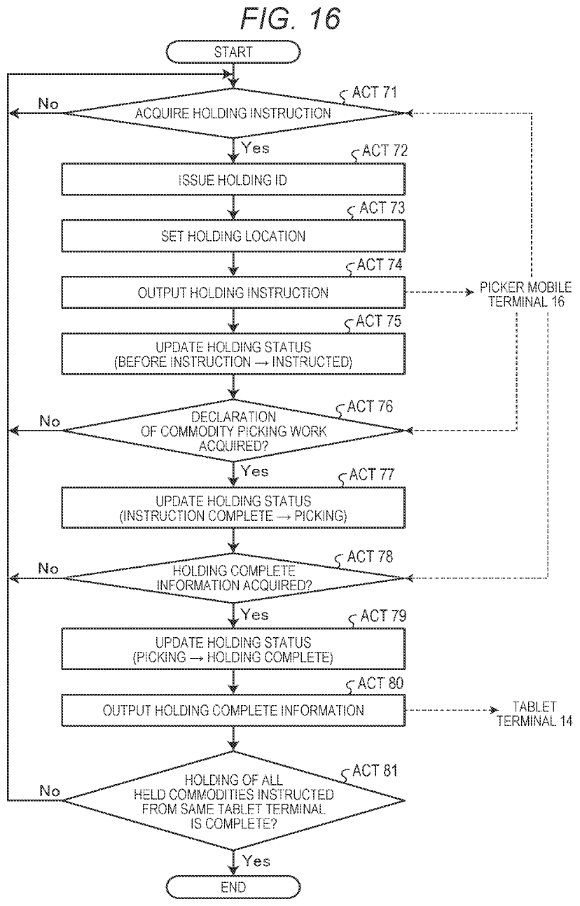

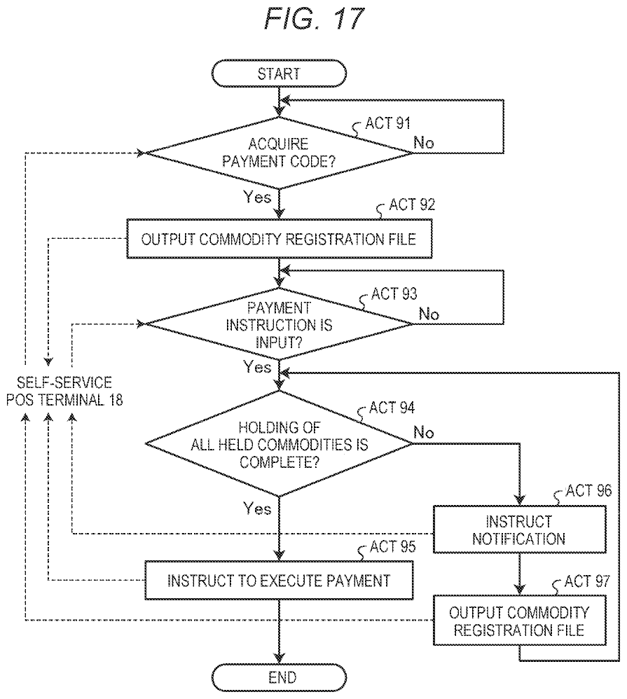

A flow of processing performed by the server device 12 will be described with reference to FIGS. 15 to 17. FIG. 15 is a flowchart illustrating an example of a flow of commodity registration and holding instruction acquisition performed by the server device. FIG. 16 is a flowchart illustrating an example of a flow of holding work declaration acquisition and holding status updating performed by the server device. FIG. 17 is a flowchart illustrating an example of a flow of payment execution instruction and notification instruction performed by the server device.

First, the flow of the commodity registration and the holding instruction acquisition performed by the server device will be described with reference to FIG. 15.

The commodity information acquisition unit 131 acquires, from the tablet terminal 14, code information that uniquely identifies a commodity to be purchased by the customer 24 and terminal identification information that uniquely identifies the tablet terminal 14 (ACT 51).

The registration information generation unit 132 generates or updates the commodity registration file 39 (ACT 52).

The commodity information acquisition unit 131 determines whether the commodity of the code information acquired in ACT 51 is a holdable commodity (ACT 53). If it is determined that the commodity is a holdable commodity (ACT 53: Yes), the processing proceeds to ACT 54. On the other hand, if it is not determined that the commodity is a holdable commodity (ACT 53: No), the processing proceeds to ACT 55.

If it is determined in ACT 53 that the commodity is a holdable commodity, the registration information generation unit 132 outputs, to the tablet terminal 14, the commodity registration file 39 generated in ACT 52 and the information indicating that the registered commodity is holdable (ACT 54). Thereafter, the processing proceeds to ACT 56.

If it is not determined in ACT 53 that the commodity is a holdable commodity, the registration information generation unit 132 outputs the commodity registration file 39 generated in ACT 52 to the tablet terminal 14 (ACT 55). Thereafter, the processing proceeds to ACT 56.

Subsequent to ACT 54 or ACT 55, the holding instruction acquisition unit 133 determines whether a holding instruction is acquired from the tablet terminal 14 (ACT 56). If it is determined that a holding instruction is acquired (ACT 56: Yes), the processing proceeds to ACT 57. On the other hand, if it is not determined that a holding instruction is acquired (ACT 56: No), the processing proceeds to ACT 62.

If it is determined in ACT 56 that a holding instruction is acquired, the holding instruction acquisition unit 133 determines whether a holding instruction was already received from the same tablet terminal 14 (ACT 57). If it is determined that a holding instruction was already received from the same tablet terminal 14 (ACT 57: Yes), the processing proceeds to ACT 58. On the other hand, if it is not determined that a holding instruction was already received from the same tablet terminal 14 (ACT 57: No), the processing proceeds to ACT 60.

If it is determined in ACT 57 that a holding instruction was already received from the same tablet terminal 14, the commodity holding information generation unit 135 assigns a new branch number to the already issued holding ID, and registers the new branch number in the commodity registration file 39 and the holding instruction file 40 (ACT 58).

The commodity holding information generation unit 135 sets the same holding location as the holding location corresponding to the already issued holding ID (ACT 59). A holding location code indicating the set holding location is registered in the commodity registration file 39 and the holding instruction file 40. Thereafter, the processing proceeds to ACT 62.

Returning to ACT 57, if it is not determined in ACT 57 that a holding instruction was already received from the same tablet terminal 14, the commodity holding information generation unit 135 issues a new holding ID (ACT 60). The issued holding ID is registered in the commodity registration file 39 and the holding instruction file 40.

The commodity holding information generation unit 135 sets the holding location of the commodity instructed to be held (ACT 61). The holding location code indicating the set holding location is registered in the commodity registration file 39 and the holding instruction file 40. The holding location may be set by the server device 12, or the holding location may be a holding location instructed by the customer 24 and acquired via the tablet terminal 14. Thereafter, the processing proceeds to ACT 62.

Subsequent to ACT 59 or ACT 61, the commodity information acquisition unit 131 determines whether the registration of all the commodities is complete (ACT 62). If it is determined that the registration of all the commodities is complete (ACT 62: Yes), the server device 12 ends the processing of FIG. 15. On the other hand, if it is not determined that the registration of all the commodities is complete (ACT 62: No), the processing returns to ACT 51. The completion of the registration of all the commodities may be determined based on, for example, whether information indicating the registration completion instructed by the customer 24 is acquired via the tablet terminal 14.

Next, a flow of the holding work declaration acquisition and the holding status updating performed by the server device will be described with reference to FIG. 16.

The holding instruction acquisition unit 133 determines whether the holding instruction is acquired from the tablet terminal 14 (ACT 71). If it is determined that a holding instruction is acquired (ACT 71: Yes), the processing proceeds to ACT 72. On the other hand, if it is not determined that a holding instruction is acquired (ACT 71: No), ACT 71 is repeated. The processing performed here corresponds to ACT 56 of FIG. 15.

If it is determined in ACT 71 that a holding instruction is acquired, the commodity holding information generation unit 135 issues a holding ID (ACT 72). As described above, if the holding instruction from the same tablet terminal 14 is present, a new branch number is assigned to the same holding ID as the already issued holding ID. The processing performed here corresponds to ACT 58 and ACT 60 in FIG. 15.

The commodity holding information generation unit 135 sets the holding location of the commodity instructed to be held (ACT 73). The holding location code indicating the set holding location is registered in the commodity registration file 39 and the holding instruction file 40. The processing performed here corresponds to ACT 59 and ACT 61 in FIG. 15.

The commodity holding instruction unit 136 outputs, to the picker mobile terminal 16, the holding instruction of the commodity to the holding location (ACT 74).

The holding status acquisition unit 137 updates the holding status from “before instruction” to “instructed” (ACT 75).

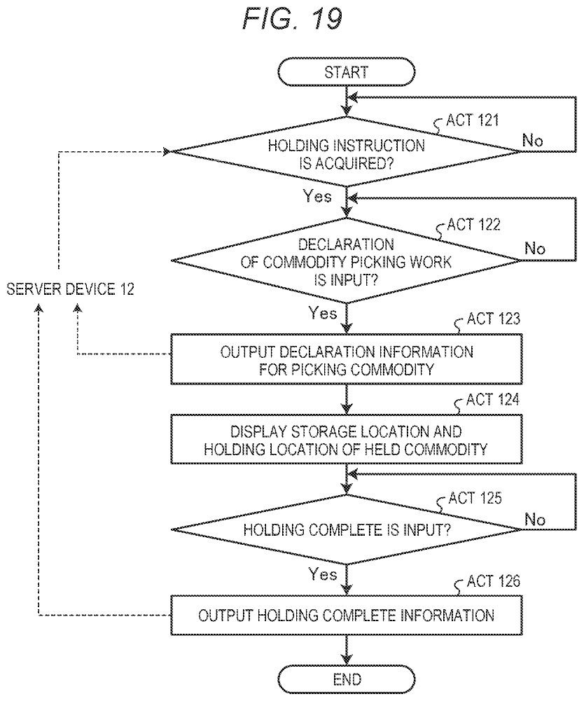

The holding status acquisition unit 137 determines whether a declaration of a commodity picking work is acquired from the picker mobile terminal 16 (ACT 76). If it is determined that a declaration of the commodity picking work is acquired (ACT 76: Yes), the processing proceeds to ACT 77. On the other hand, if it is not determined that a declaration of the commodity picking work is acquired (ACT 76: No), the processing returns to ACT 71. The declaration of the commodity picking work is output from the picker mobile terminal 16 in ACT 123 of FIG. 19 to be described later.

If it is determined in ACT 76 that a declaration of the commodity picking work is acquired, the holding status acquisition unit 137 updates the holding status from “instructed” to “picking” (ACT 77).

The holding status acquisition unit 137 determines whether the holding complete information indicating that the commodity picking work is complete is acquired from the picker mobile terminal 16 (ACT 78). If it is determined that holding complete information is acquired (ACT 78: Yes), the processing proceeds to ACT 79. On the other hand, if it is not determined that holding complete information is acquired (ACT 78: No), the processing returns to ACT 71. The holding complete information is output from the picker mobile terminal 16 in ACT 126 of FIG. 19 to be described later.

If it is determined in ACT 78 that holding complete information is acquired, the holding status acquisition unit 137 updates the holding status from “picking” to “holding complete” (ACT 79).

The holding complete information output unit 138 outputs, to the tablet terminal 14 from which the holding instruction is output, the holding complete information indicating that the holding is complete and the information indicating the holding location (ACT 80).

The holding status acquisition unit 137 determines whether the holding of all the held commodities instructed from the same tablet terminal 14 is complete (ACT 81). If it is determined that the holding of all the held commodities is complete (ACT 81: Yes), the server device 12 ends the processing of FIG. 16. On the other hand, if it is not determined that the holding of all the held commodities is complete (ACT 81: No), the processing returns to ACT 71.

Next, a flow of the payment execution instruction and the notification instruction performed by the server device will be described with reference to FIG. 17.

The payment code acquisition unit 139 acquires the payment code read by the self-service POS terminal 18 from the tablet terminal 14 (ACT 91).

The payment execution instruction unit 141 outputs the commodity registration file 39 corresponding to the payment code to the self-service POS terminal 18 (ACT 92).

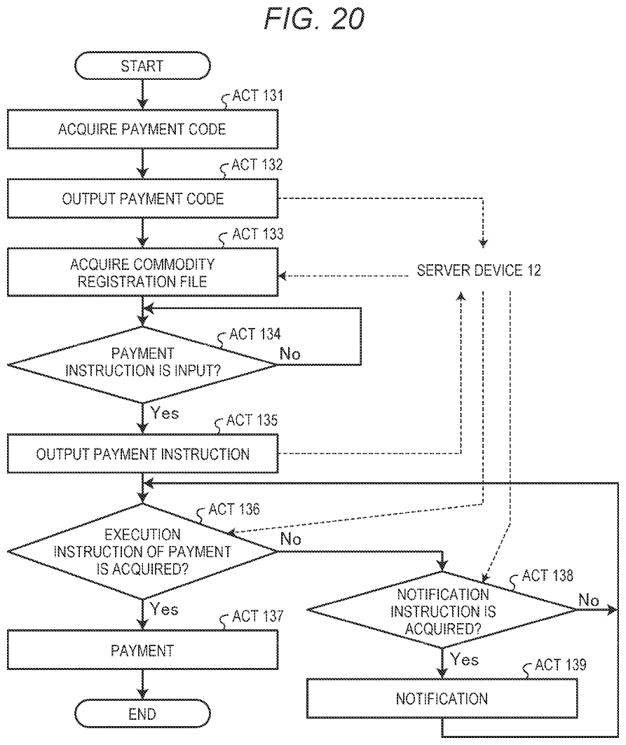

The payment execution instruction unit 141 determines whether the execution of the payment is instructed from the self-service POS terminal 18 (ACT 93). If it is determined that the execution of the payment is instructed (ACT 93: Yes), the processing proceeds to ACT 94. On the other hand, if it is not determined that the execution of the payment is instructed (ACT 93: No), ACT 93 is repeated. The execution instruction of the payment is output from the self-service POS terminal 18 in ACT 135 of FIG. 20 described later.

If it is determined in ACT 93 that the execution of the payment is instructed, the holding status acquisition unit 137 determines whether the holding of all the held commodities instructed to be held from the same tablet terminal 14 is complete (ACT 94). If it is determined that the holding of all the held commodities is complete (ACT 94: Yes), the processing proceeds to ACT 95. On the other hand, if it is not determined that the holding of all the held commodities is complete (ACT 94: No), the processing proceeds to ACT 96.

If it is determined in ACT 94 that the holding of all the held commodities is the complete, payment execution instruction unit 141 instructs the self-service POS terminal 18 to execute payment (ACT 95). Thereafter, the server device 12 ends the processing of FIG. 17.

On the other hand, if it is not determined in ACT 94 that the holding of all the held commodities is complete, the notification instruction unit 140 instructs the self-service POS terminal 18 to execute notification (ACT 96).

Thereafter, the payment execution instruction unit 141 outputs the commodity registration file 39 corresponding to the payment code to the self-service POS terminal 18 (ACT 97). Thereafter, the processing returns to ACT 94.

### (Flow of Processing Performed by Tablet Terminal)

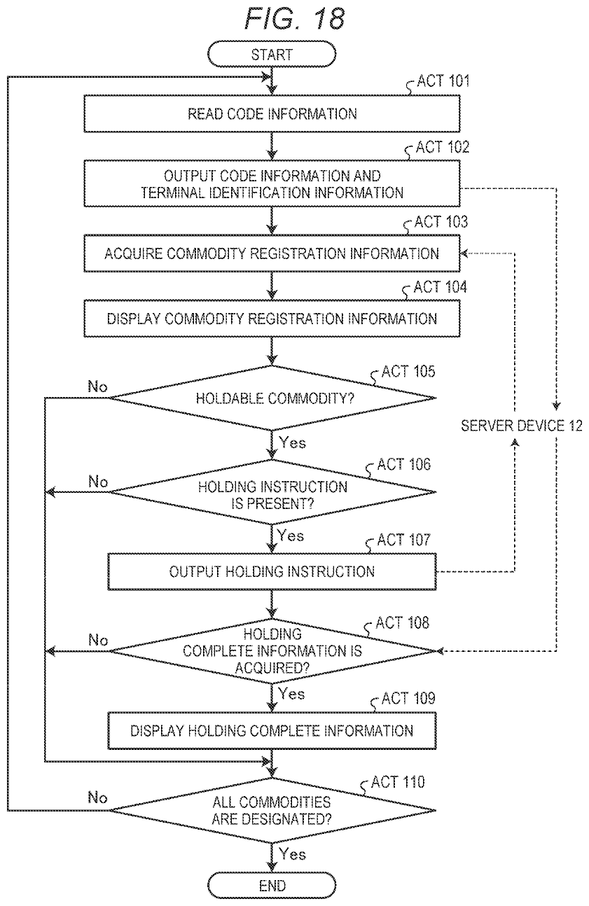

A flow of processing performed by the tablet terminal 14 will be described with reference to FIG. 18. FIG. 18 is a flowchart illustrating an example of the flow of the processing performed by the tablet terminal.

The commodity code reading unit 151 reads, by the camera 67, code information including a commodity code such as a barcode or a two-dimensional code attached to a commodity (ACT 101).

The commodity code output unit 152 outputs, to the server device 12, the code information read by the commodity code reading unit 151 and the terminal identification information uniquely identifying the tablet terminal 14 (ACT 102).

The registration information acquisition unit 153 acquires, from the server device 12, the commodity registration information registered in the commodity registration file 39 (ACT 103).

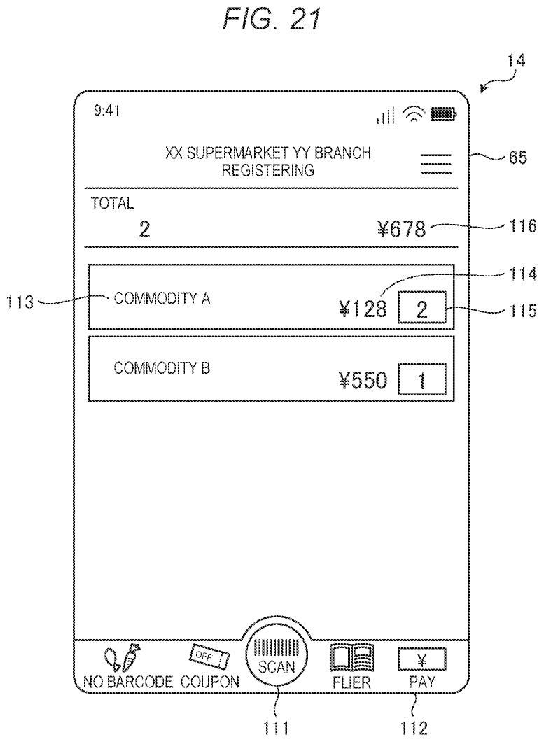

The registration information acquisition unit 153 displays the commodity registration information acquired in ACT 103 on the display device 65 (ACT 104). At this time, for example, a screen illustrated in FIG. 21 is displayed on the tablet terminal 14. A content of the screen will be described later.

The holding instruction acquisition unit 154 determines whether the commodity registered in the commodity registration information acquired in ACT 103 is a holdable commodity (ACT 105). If it is determined that the commodity is a holdable commodity (ACT 105: Yes), the processing proceeds to ACT 106. On the other hand, if it is not determined that the commodity is a holdable commodity (ACT 105: No), the processing proceeds to ACT 110.

If it is determined in ACT 105 that the commodity is a holdable commodity, the holding instruction acquisition unit 154 determines whether a holding instruction is present (ACT 106). If it is determined that a holding instruction is present (ACT 106: Yes), the processing proceeds to ACT 107. On the other hand, if it is not determined a holding instruction is present (ACT 106: No), the processing proceeds to ACT 110. At this time, for example, a screen illustrated in FIG. 22 is displayed on the tablet terminal 14. For example, when it is detected that the holding wish button 118 (illustrated in FIG. 22) displayed on the display device 65 of the tablet terminal 14 is pressed by the customer 24, the holding instruction acquisition unit 154 may determine that a holding instruction is present. A content of the screen of FIG. 22 will be described later.

If it is determined in ACT 106 that a holding instruction is present, the holding instruction output unit 155 outputs, to the server device 12, that a holding instruction of the customer 24 is present (ACT 107).

The holding complete information acquisition unit 156 determines whether the holding complete information has been acquired from the server device 12 (ACT 108). If it is determined that holding complete information has been acquired (ACT 108: Yes), the processing proceeds to ACT 109. On the other hand, if holding complete information has not been acquired (ACT 108: No), the processing proceeds to ACT 110.

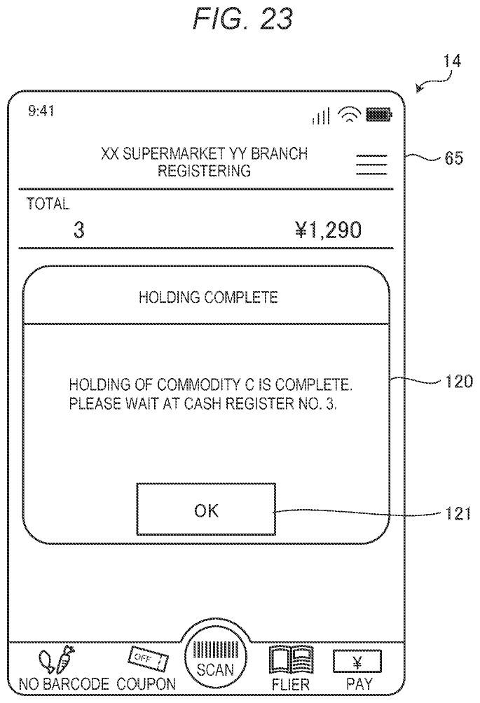

If it is determined in ACT 108 that holding complete information has been acquired, the holding complete information acquisition unit 156 displays the acquired holding complete information on the display device 65 (ACT 109). At this time, for example, a screen illustrated in FIG. 23 is displayed on the tablet terminal 14.

The commodity designation complete determination unit 157 determines whether all the commodities to be purchased have been designated by the customer 24 (ACT 110). If it is determined that all the commodities to be purchased have been designated (ACT 110: Yes), the tablet terminal 14 ends the processing of FIG. 18. On the other hand, if it is not determined that all the commodities to be purchased have been designated (ACT 110: No), the processing returns to ACT 101. Whether all the commodities to be purchased are designated is determined by detecting that, for example, a commodity designation complete button displayed on the display device 65 of the tablet terminal 14 has been pressed by customer 24. The commodity designation complete button may be a button (for example, an operation key for starting settlement in a tablet device or an operation key for displaying a payment code) for inputting that the commodity registration is complete or inputting an operation for proceeding to payment.

### (Flow of Processing Performed by Picker Mobile Terminal)

A flow of processing performed by the picker mobile terminal 16 will be described with reference to FIG. 19. FIG. 19 is a flowchart illustrating an example of the flow of the processing performed by the picker mobile terminal 16.

The commodity holding information acquisition unit 171 determines whether a holding instruction of a commodity to a holding location is acquired from the server device 12 (ACT 121). If it is determined that a holding instruction of the commodity to the holding location is acquired (ACT 121: Yes), the processing proceeds to ACT 122. On the other hand, if it is not determined that a holding instruction of the commodity to the holding location is acquired (ACT 121: No), ACT 121 is repeated. For example, a screen illustrated in FIG. 25 is displayed on the picker mobile terminal 16 in which the holding instruction of the commodity to the holding location is acquired. A content of the screen will be described later.

If it is determined in ACT 121 that a holding instruction of the commodity to the holding location is acquired, the take-charge-of-holding declaration acquisition unit 172 determines whether declaration information for performing a picking work of the commodity is acquired from a picker in response to the holding instruction acquired by the commodity holding information acquisition unit 171 (ACT 122). If it is determined that declaration information is acquired (ACT 122: Yes), the processing proceeds to ACT 123. On the other hand, if it is not determined that declaration information is acquired (ACT 122: No), ACT 122 is repeated.

If it is determined in ACT 122 that declaration information is acquired, the take-charge-of-holding declaration output unit 173 outputs the declaration information acquired by the take-charge-of-holding declaration acquisition unit 172 to the server device 12 (ACT 123).

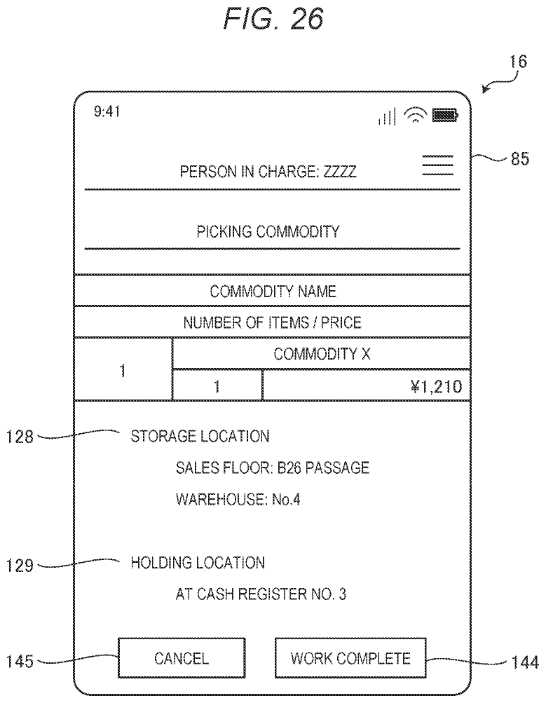

The held commodity storage location and holding location display unit 174 displays a storage location and a holding location of a held commodity on the picker mobile terminal 16 of the picker that declares to pick the held commodity (ACT 124). At this time, a screen illustrated in FIG. 26 can be displayed on the picker mobile terminal 16 of the picker.

The holding complete information acquisition unit 175 determines whether information indicating that the holding of the commodity is complete is input to the picker mobile terminal 16 of the picker (ACT 125). If the holding of the commodity is complete (ACT 125: Yes), the processing proceeds to ACT 126. On the other hand, if the holding of the commodity is not complete (ACT 125: No), ACT 125 is repeated.

If it is determined in ACT 125 that information indicating that the holding of the commodity is complete is input, the holding complete information output unit 176 outputs, to the server device 12, the information indicating that the holding of the commodity is complete (ACT 126). Thereafter, the picker mobile terminal 16 ends the processing of FIG. 19.

Although not specifically illustrated in the flowchart of FIG. 19, if one picker declares to pick a commodity, depending on an instruction of the server device 12 that acquired the declaration, a holding instruction in the picker mobile terminal 16 of another picker that previously declared to pick the held commodity can be deleted.

### (Flow of Processing Performed by Self-Service POS Terminal)

A flow of processing performed by the self-service POS terminal 18 will be described with reference to FIG. 20. FIG. 20 is a flowchart illustrating an example of the flow of the processing performed by the self-service POS terminal 18.

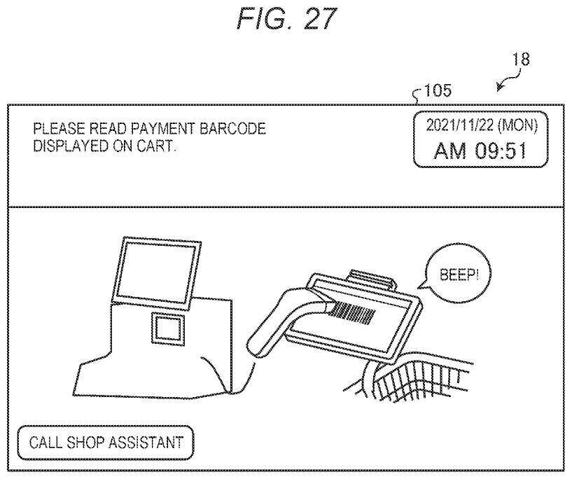

The payment code reading unit 191 causes the code reader 107 to read a payment code displayed on the tablet terminal 14 by the payment code display unit 158 (ACT 131). At this time, for example, a screen illustrated in FIG. 27 is displayed on the self-service POS terminal 18. A content of the screen will be described later.

The payment code output unit 192 outputs, to the server device 12, the payment code read by the payment code reading unit 191 (ACT 132).

The registration information acquisition unit 193 acquires, from the server device 12, the commodity registration file 39 corresponding to the payment code output by the payment code output unit 192 (ACT 133).

The payment execution instruction acquisition unit 194 determines whether an input for instructing execution of payment is present (ACT 134). If it is determined that an input for instructing the execution of the payment is present (ACT 134: Yes), the processing proceeds to ACT 135. On the other hand, if it is not determined that an input for instructing the execution of the payment is present (ACT 134: No), ACT 134 is repeated.

If it is determined in ACT 134 that an input for instructing the execution of the payment is present, the payment execution instruction output unit 195 outputs, to the server device 12, information for instructing the execution of the payment (ACT 135).

The payment execution unit 196 determines whether a payment instruction is acquired from the server device 12 (ACT 136). If it is determined that a payment instruction is acquired from the server device 12 (ACT 136: Yes), the processing proceeds to ACT 137. On the other hand, if it is not determined that a payment instruction is acquired from the server device 12 (ACT 136: No), the processing proceeds to ACT 138.

If it is determined in ACT 136 that a payment instruction is acquired from the server device 12, the payment execution unit 196 executes the payment. Thereafter, the self-service POS terminal 18 ends the processing of FIG. 20. Then, after completing the payment, the customer 24 goes to a predetermined holding location and receives the held commodity. Alternatively, a shop assistant of the holding location may confirm that the payment is performed by the customer 24, and hands over the held commodity to the customer 24.

If it is not determined in ACT 136 that a payment instruction is acquired from the server device 12, the notification information output unit 197 determines whether a notification instruction is acquired from the server device 12 (ACT 138). If it is determined that a notification instruction is acquired device 12 (ACT 138: Yes), the processing proceeds to ACT 139. On the other hand, if it is not determined that a notification instruction is acquired from the server device 12 (ACT 138: No), the processing returns to ACT 136.

The processing performed by the server device 12 illustrated in FIGS. 20 and 17 does not execute the payment unless the holding of all the commodities instructed to be held is complete, and the processing is not limited thereto. For example, even if the holding of all the held commodities is not complete, the server device 12 may cause the self-service POS terminal 18 to execute the payment when the customer 24 inputs a payment instruction from the self-service POS terminal 18. Alternatively, even if the holding of all the held commodities is not complete, the server device 12 may cause the tablet terminal 14 to execute the payment when the customer 24 inputs a payment instruction in the tablet terminal 14. In this case, after completing the payment, the customer 24 waits at the holding location until the picking of all the held commodities is complete, and receives the held commodities.

The commodity sales data processing system 10 can have a system configuration different from the system configuration illustrated in FIG. 1. For example, the customer 24 may use a mobile terminal (smartphone) instead of the tablet terminal 14, or the customer 24 may perform payment a clerk-manned POS terminal or via the mobile terminal of the customer instead of the self-service POS terminal 18, a basic flow of the above-described flowchart is not changed.

### (Representative Screen Displayed on Tablet Terminal)

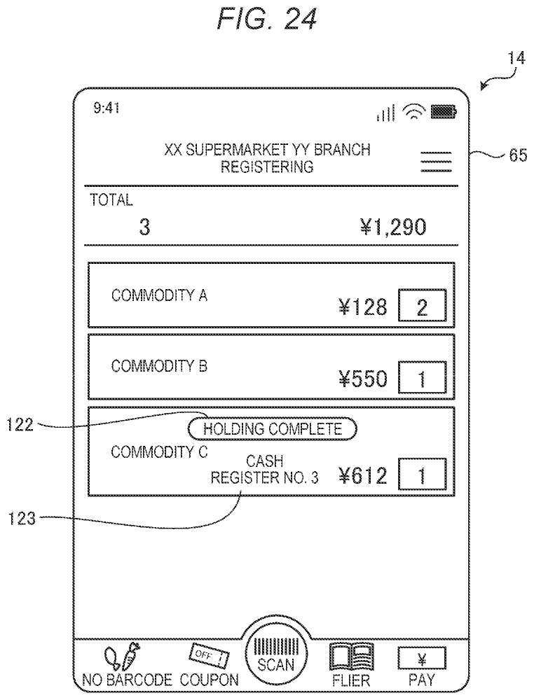

A representative screen displayed on the display device 65 of the tablet terminal 14 will be described with reference to FIGS. 21 to 24. FIG. 21 is a first diagram illustrating an example of a commodity registration screen, which is displayed on the tablet terminal. FIG. 22 is a diagram illustrating an example of a holding request input screen for holdable commodities, which is displayed on the tablet terminal. FIG. 23 is a diagram illustrating an example of a screen indicating that holding of the commodities displayed on the tablet terminal is complete. FIG. 24 is a second diagram illustrating an example of the commodity registration screen, which is displayed on the tablet terminal.

FIG. 21 is an example of a screen on which a list of commodities registered by the customer 24 is displayed. At this time, a commodity name 113, a unit price 114, and a quantity 115 of a registered commodity are displayed for each commodity on the display device 65 of the tablet terminal 14. A total price 116 of all the commodities is displayed. The screen of FIG. 21 is displayed, for example, in ACT 104 of the flowchart of FIG. 18.

A basic operation icon is displayed on a lower part of the screen of the display device 65 of the tablet terminal 14. For example, when code information for a commodity is to be read, a scan button 111 is pressed to activate the camera 67. If payment is to be performed at the self-service POS terminal 18, a payment button 112 is pressed, and the display device 65 displays a payment code.

FIG. 22 is an example of a screen displayed on the display device 65 of the tablet terminal 14 if the commodity registered by the customer 24 is a holdable commodity. At this time, a message window 117 indicating that the commodity is a holdable commodity is displayed on the display device 65 of the tablet terminal 14. Then, the holding wish button 118 and a holding not required button 119 are displayed on the inside of the message window 117. The screen of FIG. 22 is displayed, for example, in ACT 106 of processing of the flowchart of FIG. 18.

FIG. 23 is an example of the screen displayed on the display device 65 of the tablet terminal 14 when the instructed holding is complete. At this time, a message window 120 indicating that the holding is complete is displayed on the display device 65 of the tablet terminal 14. Then, a confirm button 121 is displayed on the inside of the message window 120. The screen of FIG. 23 is displayed, for example, in ACT 109 of the processing of the flowchart of FIG. 18.

FIG. 24 is an example of a screen on which a list of commodities registered by the customer 24 is displayed, the screen being displayed on the display device 65 of the tablet terminal 14. In particular, FIG. 24 is an example including commodities instructed to be held by the customer 24. Specifically, a commodity C displayed in FIG. 24 is a commodity instructed to be held. When holding of the commodity instructed to be held is complete, a holding complete icon 122 and holding location information 123 are displayed in a column for the commodity C. Although not illustrated, a holding wait icon instead of the holding complete icon 122 may be displayed in a column for indicating the holding is not yet complete.

### (Representative Screen Displayed on Picker Mobile Terminal)

A representative screen displayed on the display device 85 of the picker mobile terminal 16 will be described with reference to FIGS. 25 and 26. FIG. 25 is a diagram illustrating an example of a screen for declaring to hold commodities, the screen being displayed on the picker mobile terminal. FIG. 26 is a diagram illustrating an example of a screen illustrating a storage location and a holding location of the held commodities, the screen being displayed on the picker mobile terminal.

FIG. 25 is an example of, when the server device 12 received a holding instruction of a commodity from the customer 24 and outputs the holding instruction to the picker mobile terminal 16, a screen displayed on the display device 85 of the picker mobile terminal 16 that acquired the holding instruction. Commodity information 124 indicating a held commodity and a message window 125 for requesting to take charge to pick the commodity are displayed on the display device 85 of the picker mobile terminal 16. The OK button 126 for declaring to take charge of a picking work and a cancel button 127 for notifying to cancellation of a previous take charge of the picking work are displayed inside the message window 125. The screen of FIG. 25 is displayed, for example, when a transaction instruction is acquired in ACT 121 of the flowchart of FIG. 19.

FIG. 26 is an example of a screen illustrating a storage location and a holding location of a held commodity, which are displayed on the display device 85 of the picker mobile terminal 16 for picking work of the held commodity. A storage location 128 of the held commodity and a holding location 129 of the held commodity are displayed on the display device 85 of the picker mobile terminal 16. The storage location 128 of the held commodity includes a display position of the corresponding commodity in the store and a storage location of the corresponding commodity in a backyard. The holding location 129 of the held commodity is a holding position set by the server device 12. On the screen of FIG. 26, a work complete button 144 and a work cancel button 145 are displayed. The work complete button 144 is a button for transmitting the complete of the picking work to the server device 12 when the picker completes carrying the commodity to the holding location. The work cancel button 145 is a button for transmitting a cancellation of the picking work to the server device 12 when the picking work is canceled due to occurrence of another work or the like. The screen of FIG. 26 is displayed, for example, at a timing of ACT 124 of the flowchart of FIG. 19. Although not mentioned above, when the work cancel button 145 is pressed, the server device 12 outputs, to a plurality of picker mobile terminals 16, a transaction instruction for the same held commodity again so another picker may complete the holding task.

### (Representative Screen Displayed on Self-Service POS Terminal)

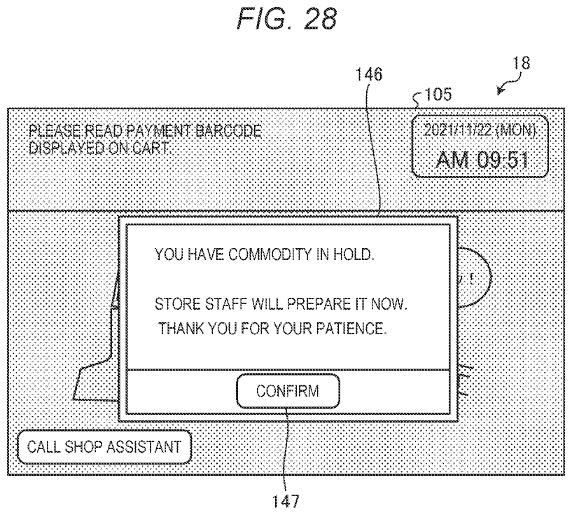

A representative screen displayed on the display device 105 of the self-service POS terminal 18 will be described with reference to FIGS. 27 and 28. FIG. 27 is a diagram illustrating an example of a screen displayed on the self-service POS terminal when a customer starts payment. FIG. 28 is a diagram illustrating an example of a screen displayed when not all of commodities requested to be held are picked into the holding location when the customer starts payment.

FIG. 27 is an example of a screen that is initially displayed when the customer 24 performs payment on the self-service POS terminal 18. The display device 105 of the self-service POS terminal 18 displays a pattern indicating that a payment code displayed on the tablet terminal is read by the code reader of the self-service POS terminal. When seeing the screen of FIG. 27, the customer 24 causes the tablet terminal 14 to display the payment code, and causes the code reader 107 provided in the self-service POS terminal 18 to read the payment code. A call button for calling a shop assistant may be displayed on the screen. The screen of FIG. 27 is displayed, for example, in ACT 131 of the processing of the flowchart of FIG. 20.

Although display of the screen depicted in FIG. 28 is not described in conjunction with flowcharts described above, the self-service POS terminal 18 may display on the display device 105 a message window 146 indicating that the shop assistant is still working to prepare the held commodity if a held commodity is present in the commodities registered by the customer 24 who instructs payment. A confirm button 147 for transmitting to the server device 12 that the message is confirmed (acknowledged) is displayed on the inside of the message window 146. The fact of the pressing of the confirm button 147 can be transmitted to the server device 12. The server device 12 then outputs information for identifying the held commodity and information for identifying the self-service POS terminal 18 at which the customer is performing payment to a mobile terminal carried by staff at the holding location where the held commodity of the customer 24 has been placed. Then, the staff at the holding location brings the held commodity to the customer 24 and hands over the commodity to the customer 24.

### Functions and Effects of Embodiment

As described above, the server device 12 (commodity sales data processing device) according to an embodiment includes: a registration information generation unit 132 that generates registration information including commodity information about commodities to be purchased by the customer 24 and associates the generated registration with a payment code uniquely identifying the registration information. The registration information is acquired from the tablet terminal 14 (first mobile terminal). A holding instruction acquisition unit 133 acquires, from the tablet terminal 14, a holding instruction for each holdable commodity included in the commodities to be purchased. A commodity holding information generation unit 135 generates commodity holding information in which a commodity code (first identification information) identifying a commodity instructed to be held, terminal identification information (second identification information) identifying the holding instruction from the tablet terminal 14, and a holding location for the commodity are associated with each other. A commodity holding instruction unit 136 outputs, to the picker mobile terminal 16 (second mobile terminal), the holding instruction (s). A payment execution instruction unit 141 causes the self-service POS terminal 18 to perform payment processing related to the registration information when the payment code is sent from the self-service POS terminal 18 (payment device). Therefore, even if a commodity to be held and a commodity not to be held are mixed in the sales transaction, the payment processing can be performed without causing a customer to perform any special operation. As such, the customer 24 does not need to drag the shopping cart 23 while having a large commodity or heavy commodity placed thereon. Further, since no large or heavy object is required to be placed on the shopping cart 23, the life of the shopping cart 23 can be extended.

The server device 12 (commodity sales data processing device) according to the embodiment further includes: a holding status acquisition unit 137 that acquires, from the picker mobile terminal 16 (second mobile terminal), information indicating a holding status of the items instructed to be held; and a holding complete information output unit 138 that outputs to the tablet terminal 14 (first mobile terminal) information indicating that the holding is complete along with information indicating the holding location assuming that picking of the requested items and transfer to the holding location is complete. Therefore, the customer 24 can understand that the holding of the requested items is complete, and understand at which holding location the items are located.

The server device 12 (commodity sales data processing device) according to the embodiment further includes the notification instruction unit 140 that causes the self-service POS terminal 18 to perform notification when picking of all commodities instructed to be held into the holding location is not complete when the self-service POS terminal 18 (payment device) performs payment processing. Therefore, the customer 24 can immediately recognize that the holding of all the commodities instructed to be held is not yet complete.

The server device 12 (commodity sales data processing device) according to the embodiment further includes the payment code output unit 134 that outputs the payment code to the tablet terminal 14 (first mobile terminal) when the customer 24 has finished shopping (e.g., sent a registration end instruction or the like). When notice indicating that the payment code has been read from the tablet terminal 14 by the self-service POS terminal 18 is acquired from the self-service POS terminal 18 (payment device), the notification instruction unit 140 causes the self-service POS terminal 18 to perform a notification indicating whether or not the movement of all requested items to the holding location is complete. Therefore, the customer 24 can immediately recognize that not the holding of all the commodities instructed to be held has been complete.

In the server device 12 (commodity sales data processing device) according to the embodiment, after payment is executed by the self-service POS terminal 18 (payment device) but not all of the commodities instructed to be held at the holding location is complete, a completion notification may be sent later once all the commodities instructed to be held have been moved to the holding location. For example, holding complete information output unit 138 outputs to the tablet terminal 14 (first mobile terminal) a completion notice. Therefore, the customer 24 can complete payment before all the commodities instructed to be held has been completed. The customer 24 thus waits for the completion of the holding of the commodities.

While certain embodiments have been described, these embodiments are presented simply as examples and are not intended to limit the scope of the present disclosure. These novel embodiments can be carried out in various other forms or with various omissions, replacements, changes, and combinations without departing from the spirit and scope of the present disclosure. These embodiments and the modifications thereof are included in the spirit and scope of the present disclosure and also included in the scope of the claims and equivalents thereof.

What is claimed is:

1. A commodity sales data processing device, comprising:
a communication interface; and
a control unit configured to:
receive a commodity code from a first terminal for an item being registered in a sales transaction and store the commodity code in association with a payment code as sales transaction information;
receive a holding instruction from the first terminal for an item registered in the sales transaction that is a holdable commodity;
generate commodity holding information in which the commodity code identifying the item instructed to be held, terminal identification information identifying the first terminal, and a holding location of the item are associated with each other;
output a picking instruction to a second terminal, the picking instruction including the commodity code of the item instructed to be held and the holding location for the item; and
transmit the sales transaction information to a payment device when the payment device sends the payment code associated with the sales transaction information.

2. The commodity sales data processing device according to claim 1, wherein the control unit is further configured to:
receive information indicating a holding status of the item instructed to be held; and
output information indicating that the picking of the item instructed to be held is complete along with a holding location when the item is at the holding location.

3. The commodity sales data processing device according to claim 2, wherein the control unit is further configured to:
output information indicating that the picking of the item instructed to be held is not complete when the item is not at the holding location.

4. The commodity sales data processing device according to claim 1, wherein the control unit is further configured to:
output the payment code to the first terminal when a registration complete instruction is received from the first terminal.

5. The commodity sales data processing device according to claim 4, wherein the control unit is further configured to:
output a notice to the payment device in response to the payment code being sent from the payment device, the notice indicating the holding status of the item instructed to be held when the payment code is received.

6. The commodity sales data processing device according to claim 4, wherein the control unit is further configured to:
output a notice to the first terminal in response to the payment code being sent from the payment device, the notice indicating the holding status of the item instructed to be held when the payment code is received.

7. The commodity sales data processing device according to claim 6, wherein the notice includes the holding location of the item.

8. A commodity sales data processing system, comprising:
a first terminal for registering items in a sales transaction;
a second terminal for receiving item picking instructions; and
a payment terminal for receiving payments for settling the sales transaction; and
a commodity sales data processing device including:
a communication interface; and
a control unit configured to:
receive a commodity code from the first terminal for an item being registered in the sales transaction and store the commodity code in association with a payment code as sales transaction information;
receive a holding instruction from the first terminal for an item registered in the sales transaction that is a holdable commodity;
generate commodity holding information in which the commodity code identifying the item instructed to be held, terminal identification information identifying the first terminal, and a holding location of the item are associated with each other;
output a picking instruction to the second terminal, the picking instruction including the commodity code of the item instructed to be held and the holding location for the item; and
transmit the sales transaction information to the payment terminal when the payment terminal sends the payment code associated with the sales transaction information.

9. The commodity sales data processing system according to claim 8, wherein the control unit is further configured to:
receive information indicating a holding status of the item instructed to be held; and
output information indicating that the picking of the item instructed to be held is complete along with a holding location when the item is at the holding location.

10. The commodity sales data processing system according to claim 9, wherein the control unit is further configured to:
output information indicating that the picking of the item instructed to be held is not complete when the item is not at the holding location.

11. The commodity sales data processing system according to claim 8, wherein the control unit is further configured to:
output the payment code to the first terminal when a registration complete instruction is received from the first terminal.

12. The commodity sales data processing system according to claim 11, wherein the control unit is further configured to:
output a notice to the payment terminal in response to the payment code being sent from the payment terminal, the notice indicating the holding status of the item instructed to be held when the payment code is received.

13. The commodity sales data processing system according to claim 11, wherein the control unit is further configured to:
output a notice to the first terminal in response to the payment code being sent from the payment device, the notice indicating the holding status of the item instructed to be held when the payment code is received.

14. The commodity sales data processing system according to claim 13, wherein the notice includes the holding location of the item.

15. A commodity sales data processing method, comprising:
receiving a commodity code from a first terminal for an item being registered in a sales transaction and storing the commodity code in association with a payment code as sales transaction information;
receiving a holding instruction from the first terminal for an item registered in the sales transaction that is a holdable commodity;
generating commodity holding information in which the commodity code identifying the item instructed to be held, terminal identification information identifying the first terminal, and a holding location of the item are associated with each other;
outputting a picking instruction to a second terminal, the picking instruction including the commodity code of the item instructed to be held and the holding location for the item; and
transmitting the sales transaction information to a payment device when the payment device sends the payment code associated with the sales transaction information.

16. The commodity sales data processing method according to claim 15, further comprising:
receiving information indicating a holding status of the item instructed to be held; and
outputting information indicating that the picking of the item instructed to be held is complete along with a holding location when the item is at the holding location.

17. The commodity sales data processing method according to claim 16, further comprising:
outputting information indicating that the picking of the item instructed to be held is not complete when the item is not at the holding location.

18. The commodity sales data processing method according to claim 15, further comprising:
outputting the payment code to the first terminal when a registration complete instruction is received from the first terminal.

19. The commodity sales data processing method according to claim 18, further comprising:
outputting a notice to the payment device in response to the payment code being sent from the payment device, the notice indicating the holding status of the item instructed to be held when the payment code is received.

20. The commodity sales data processing method according to claim 18, further comprising:
outputting a notice to the first terminal in response to the payment code being sent from the payment device, the notice indicating the holding status of the item instructed to be held when the payment code is received.
